(19) United States
(12) Patent Application Publication
(10) Pub. No.: US 2011/0214773 A1
(43) Pub. Date: Sep. 8, 2011

(54) METHOD OF MANUFACTURING RUBBER HOSE REINFORCED BY STEEL CORDS, AND RUBBER HOSE REINFORCED BY STEEL CORDS

(75) Inventors: Yousuke Hamachi, Kanagawa-ken (JP); Akira Onodera, Kanagawa-ken (JP); Shuichi Toriumi, Kanagawa-ken (JP)

(73) Assignee: THE YOKOHAMA RUBBER CO., LTD., Tokyo (JP)

(21) Appl. No.: 13/062,467

(22) PCT Filed: Sep. 2, 2009
(86) PCT No.: PCT/JP2009/004329

§ 371 Date: May 24, 2011

(30) Foreign Application Priority Data
Sep. 4, 2008 (JP) 2008-226566
Sep. 4, 2008 (JP) 2008-226732

(51) Int. Cl. F16L 11/08; B32B 37/18

(52) U.S. Cl. 138/137; 156/144

(57) ABSTRACT

A method of manufacturing a rubber hose reinforced by a plurality of helically arranged steel cords is provided. The rubber hose includes an inner tube, an outer tube, and a laminated reinforcing layer between the inner and outer tubes. The reinforcing layer is formed by laminating unit layers on each other. A composite strip material is formed by embedding a plurality of reinforcing steel cords in an unvulcanized rubber strip so as to extend in the longitudinal direction thereof. The strip material is wound around the inner tube and vulcanized. The unit layers are formed from the composite strip material having a single continuous form, and each layer is formed by alternately repeating a winding pass forming step for winding the composite strip material in a first direction and a winding pass forming step for winding the composite strip material in a second direction opposite the first direction.

### TECHNICAL FIELD

The present technology relates to a method for manufacturing a rubber hose reinforced by a plurality of helically arranged steel cords and to a rubber hose reinforced by a plurality of helically arranged steel cords manufactured using said manufacturing method.

### BACKGROUND

Rubber hoses reinforced by a plurality of helically arranged reinforcing cords (i.e. steel cords, etc.) on a wall of the hose are used, for example, for circulating high pressure hydraulic oil in hydraulic systems. Such reinforcing cords that are helically arranged on a wall of a rubber hose have flexibility and also high tensile rigidity, and, because of this, function as reinforcing members that prevent excessive deformations caused by diameter expansion or stretching due to internal high pressure therein, while maintaining the flexibility of the rubber hose at least in part.

An example of a manufacturing device for manufacturing this type of rubber hose is described in Japanese Unexamined Patent Application Publication Number H10-44214. Rubber hoses manufactured by the manufacturing device of this publication have a laminated structure constituted by an inner tube layer that defines a cavity of the rubber hose, a reinforcing layer formed on a periphery of the inner tube layer, and an outer tube layer that is formed on a periphery of the reinforcing layer and that defines a peripheral surface of the rubber hose. The reinforcing layer is formed from a plurality of reinforcing cords that is helically arranged. The manufacturing device is a device having a composite structure integrally combining a first extruder for extrusion molding an inner tube, a cord winder (called “helix machine” in the publication) for helically winding a reinforcing cord on a peripheral surface of the extrusion molded inner tube, and a second extruder for extrusion molding an outer tube on a peripheral surface of the inner tube on which the reinforcing cords have been wound.

However, the rubber hose manufacturing device described in Japanese Unexamined Patent Application Publication No. H10-44214 carries a disadvantage in that it has a complex and costly structure. Therefore, a manufacturing method by which a rubber hose reinforced by a plurality of helically arranged steel cords can be manufactured using a less costly manufacturing device is desired.

### SUMMARY

The present technology provides a manufacturing method by which a rubber hose reinforced by a plurality of helically arranged steel cords can be manufactured using a comparatively inexpensive manufacturing device. The present technology also provides a rubber hose reinforced by a plurality of helically arranged steel cords that can be manufactured using a comparatively inexpensive manufacturing device.

One aspect of the present technology provides a method of manufacturing rubber hose reinforced by a plurality of helically arranged steel cords, the manufacturing method including the steps of: fabricating a composite strip material having opposite side surfaces and opposite side edges, wherein the composite strip material includes an unvulcanized rubber strip and a plurality of reinforcing steel cords provided in the unvulcanized rubber strip so as to be arranged in a mutually juxtaposed manner and extend in a longitudinal direction of the unvulcanized rubber strip; fabricating a flexible inner tube that forms an innermost layer of the rubber hose; and forming a laminated reinforcing layer including a plurality of the helically arranged steel cords around the inner tube by: winding the composite strip material around the inner tube, forming a wound body having a laminated structure formed by laminating a plurality of unit layers on each other, and, at that point, forming one of the unit layers on the inner tube and then sequentially forming another unit layer on the formed unit layer; and thereafter subjecting the unvulcanized rubber strip of the wound composite strip material to vulcanization. When forming each of the unit layers, one side surface of the composite strip material is abutted against a base peripheral surface upon which the unit layer is formed; and a side edge of the composite strip material forming one turn of the helix and a side edge of the composite strip material forming the turn adjacent thereto are brought into close contact, the composite strip material is helically wound on the base peripheral surface, so that the base peripheral surface is covered by the composite strip material.

Furthermore, when forming each of the unit layers, a single continuous strip of the composite strip material is used; and each of the unit layers is formed by alternately repeating a winding pass forming step in a first winding forward direction for helically winding the composite strip material in a first direction of the longitudinal direction of the base peripheral surface in a given helix direction, at a given helix angle, and at a given pitch of an integer multiple of a width dimension of the composite strip material; and a winding pass forming step in a second winding forward direction for winding the composite strip material in a second direction that is a direction opposite the first direction of the longitudinal direction of the base peripheral surface in the given helix direction, at the given helix angle, and at the given pitch.

Preferably, when alternating from the winding pass forming step in the first winding forward direction to the winding pass forming step in the second winding forward direction, the winding forward direction is reversed and also a relative winding direction of the composite strip material on the base peripheral surface is reversed.

The rubber hose reinforced by a plurality of helically arranged steel cords may also be formed by alternately laminating a unit layer formed by winding the composite strip material in a first helix direction and a unit layer formed by winding the composite strip material in a second helix direction that is a direction opposite the first helix direction.

The composite strip material may also be wound on the base peripheral surface while applying tension to the composite strip material.

A step of forming an outer tube around the laminated reinforcing layer that covers a surface of laminated reinforcing layer may also be included.

The side surface of the single continuous strip of the composite strip material that is abutted against the base peripheral surface in the winding pass forming step in the first winding forward direction and the side surface of the single continuous strip of the composite strip material that is abutted against the base peripheral surface in the winding pass forming step in the second winding forward direction may also be side surfaces on the same side.

An entirety of the steel cords of the composite strip material can be completely embedded in the unvulcanized rubber strip.

As an alternate method, a portion of a circumferential surface of the steel cords of the composite strip material can be embedded in the unvulcanized rubber strip and a remaining portion of the circumferential surface can be exposed from one side surface of the unvulcanized rubber strip.

Another aspect of the present technology provides a rubber hose reinforced by steel cords manufactured according to the manufacturing method described above.

According to the present technology, a rubber hose reinforced by a plurality of helically arranged steel cords can be manufactured by a relatively inexpensive manufacturing device.

A preferred embodiment of the present technology is described below in detail while referring to the attached drawings. The attached drawings are as follows.

### BRIEF DESCRIPTION OF THE DRAWINGS

FIG. 1A is a schematic view illustrating a cross-section of a rubber hose reinforced by a plurality of helically arranged steel cords according to an embodiment of the present technology.

FIG. 1B is a partial cut-away view of the rubber hose.

FIGS. 2A, 2B, and 2C are cross sectional views illustrating specific examples of three types of composite strip materials, and these composite strip materials can be used for manufacturing the rubber hose according to an embodiment of the present technology.

FIG. 3 is a drawing illustrating a specific example of a strip material helical winding device that can be used for manufacturing the rubber hose following the method for manufacturing a rubber hose according to an embodiment of the present technology, and is a schematic view illustrating a plan view of an arrangement of the components of the device.

FIGS. 4A and 4B are schematic views illustrating side views of a number of the arrangements of the components of the strip material helical winding device illustrated in FIG. 3.

FIGS. 5A, 5B, and 5C are explanatory diagrams illustrating a wrapping process of the composite strip material that can be performed using the strip material helical winding device illustrated in FIG. 3.

FIGS. 6A and 6B each illustrate a first step of a reversing process in the wrapping process of the composite strip material.

FIGS. 7A and 7B each illustrate a step following the step in FIGS. 6A and 6B of the reversing process in the wrapping process of the composite strip material.

FIGS. 8A and 8B each illustrate a step following the step in FIGS. 7A and 7B of the reversing process in the wrapping process of the composite strip material.

FIGS. 9A and 9B each illustrate a step following the step in FIGS. 8A and 8B of the reversing process in the wrapping process of the composite strip material.

FIGS. 10A and 10B each illustrate a step following the step in FIGS. 9A and 9B of the reversing process in the wrapping process of the composite strip material.

FIGS. 11A and 11B each illustrate a step following the step in FIGS. 10A and 10B of the reversing process in the wrapping process of the composite strip material.

FIGS. 12A and 12B each illustrate a step following the step in FIGS. 11A and 11B of the reversing process in the wrapping process of the composite strip material.

FIGS. 13A and 13B each illustrate a step following the step in FIGS. 12A and 12B of the reversing process in the wrapping process of the composite strip material.

FIGS. 14A and 14B each illustrate a step following the step in FIGS. 13A and 13B of the reversing process in the wrapping process of the composite strip material.

FIGS. 15A and 15B each illustrate a step following the step in FIGS. 14A and 14B of the reversing process in the wrapping process of the composite strip material.

FIGS. 16A and 16B each illustrate a step following the step in FIGS. 15A and 15B of the reversing process in the wrapping process of the composite strip material.

FIGS. 17A and 17B each illustrate a step following the step in FIGS. 16A and 16B of the reversing process in the wrapping process of the composite strip material.

FIGS. 18A and 18B each illustrate a step following the step in FIGS. 17A and 17B of the reversing process in the wrapping process of the composite strip material.

FIGS. 19A and 19B each illustrate a step following the step in FIGS. 18A and 18B of the reversing process in the wrapping process of the composite strip material.

FIGS. 20A and 20B each illustrate a step following the step in FIGS. 19A and 19B of the reversing process in the wrapping process of the composite strip material.

FIG. 21 is a perspective view of a left end of a mandrel, illustrating the step corresponding with FIGS. 7A and 7B of the reversing process in the wrapping process of the composite strip material.

FIG. 22 is a perspective view of the left end of the mandrel, illustrating the step following the step of FIGS. 7A and 7B of the reversing process in the wrapping process of the composite strip material.

FIG. 23 is a perspective view of the left end of the mandrel, illustrating the step corresponding with FIGS. 8A and 8B of the reversing process in the wrapping process of the composite strip material.

FIG. 24 is a perspective view of the left end of the mandrel, illustrating the step corresponding with FIGS. 9A and 9B of the reversing process in the wrapping process of the composite strip material.

FIG. 25 is a perspective view of the left end of the mandrel, illustrating the step corresponding with FIGS. 10A and 10B of the reversing process in the wrapping process of the composite strip material.

FIG. 26 is a perspective view of the left end of the mandrel, illustrating the step corresponding with FIGS. 11A and 11B of the reversing process in the wrapping process of the composite strip material.

FIG. 27 is a perspective view of the left end of the mandrel, illustrating the step corresponding with FIGS. 13A and 13B of the reversing process in the wrapping process of the composite strip material.

FIG. 28 is a perspective view of a right end of the mandrel, illustrating a first step of the reversing process in the wrapping process of the composite strip material when a mandrel provided with a latching member according to a modified embodiment is used.

FIG. 29 is a perspective view of the right end of the mandrel, illustrating a step following the step in FIG. 28 of the reversing process in the wrapping process of the composite strip material when a mandrel provided with a latching member according to the modified embodiment is used.

FIG. 30 is a perspective view of the right end of the mandrel, illustrating a step following the step in FIG. 29 of the reversing process in the wrapping process of the composite strip material when a mandrel provided with a latching member according to the modified embodiment is used.

FIG. 31 is a perspective view of the right end of the mandrel, illustrating a step following the step in FIG. 30 of the reversing process in the wrapping process of the composite strip material when a mandrel provided with a latching member according to the modified embodiment is used.

FIG. 32 is a perspective view of the right end of the mandrel, illustrating a step following the step in FIG. 31 of the reversing process in the wrapping process of the composite strip material when a mandrel provided with a latching member according to the modified embodiment is used.

FIG. 33 is a perspective view of the right end of the mandrel, illustrating a step following the step in FIG. 32 of the reversing process in the wrapping process of the composite strip material when a mandrel provided with a latching member according to the modified embodiment is used.

### DETAILED DESCRIPTION

In the following description, the term “rubber” when used in conjunction with the present technology is not limited to only natural rubbers, but includes synthetic rubbers and any elastomeric materials called by other names; examples of the elastomeric materials include homogeneous materials formed from a single elastomeric component, homogeneous materials formed by combining multiple types of elastomeric components, composite materials formed by compounding a plurality of components formed from mutually differing elastomeric components, composite materials formed by dispersing or embedding a non-elastomeric component in a base material formed from a elastomeric component, and the like; and, furthermore, include other elastomeric materials having a variety of forms that are any combination of the above. Additionally, as used in conjunction with the present technology, the term “rubber hose” refers to hoses that have rubber as a major component and also may refer to hoses that concurrently use a non-rubber material.

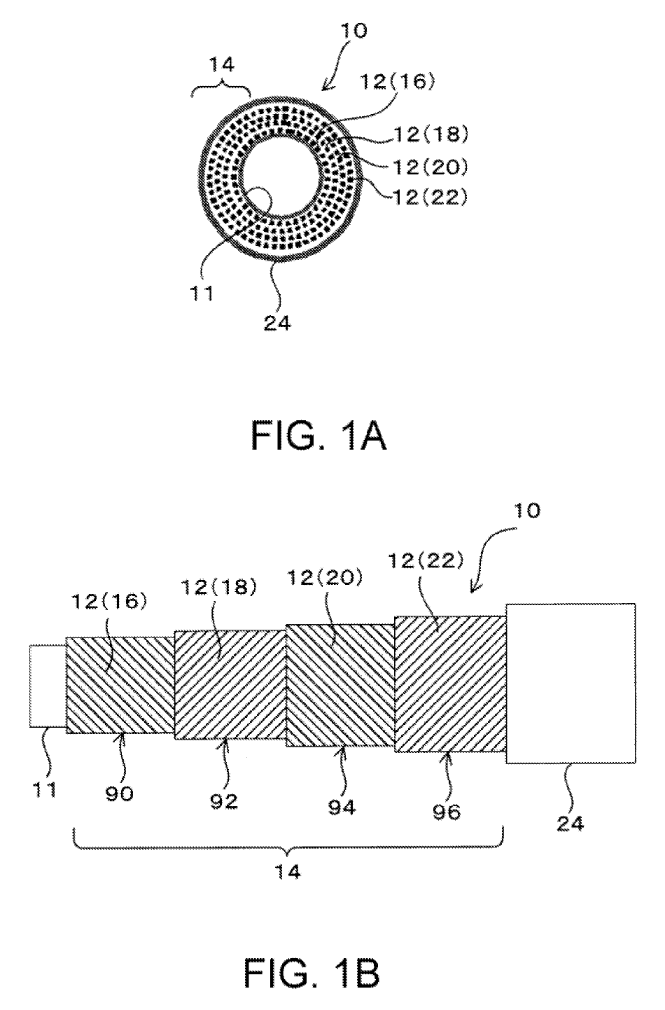

As schematically illustrated in FIG. 1A, a rubber hose 10 according to a preferable embodiment of the present technology has a concentric laminated structure. The rubber hose 10 is provided with a flexible tube 11 (hereinafter, “inner tube”) that forms an innermost layer of the laminated structure, and a cavity of the rubber hose 10 is defined by the inner tube 11. Examples of a material of the inner tube 11 include oil resistant rubber and the like. Note that the inner tube 11 itself may be configured to be a tube of the laminated structure.

The rubber hose 10 is further provided with a laminated reinforcing layer 14 formed on a periphery of the inner tube 11 The laminated reinforcing layer 14 has a structure wherein a plurality of reinforcing steel cords 12 are embedded in a base material formed from rubber. The reinforcing steel cords 12 are arranged so as to form four steel cord groups 16, 18, 20, and 22. Each of the steel cord groups 16, 18, 20, and 22 is formed from a plurality of the steel cords 12 arranged so as to extend helically and be mutually juxtaposed on a surface of a single cylinder. Moreover, the steel cord groups 16, 18, 20, and 22 are arranged in a concentric circular manner. Additionally, as illustrated in FIG. 1B, the steel cords 12 of the first steel cord group 16 and the third steel cord group 20 are wound in a first helix direction, and, on the other hand, the steel cords 12 of the second steel cord group 18 and the fourth steel cord group 22 are wound in a second helix direction that is a direction opposite the first helix direction. The steel cords 12 have flexibility and also high tensile rigidity, and, because of this, function as reinforcing members that prevent excessive deformations caused by diameter expansion or stretching due to internal high pressure therein, while maintaining the flexibility of the rubber hose 10 at least in part. Hereinafter, the process for forming the laminated reinforcing layer 14 described above will be explained.

The rubber hose 10 is further provided with a flexible tube 24 (hereinafter, “outer tube”) that is formed around the laminated reinforcing layer 14. The outer tube 24 forms an outermost layer of the laminated structure of the rubber hose 10, and examples of a material of the outer tube 24 include wear resistant rubber and the like. Note that the outer tube 24 itself may be configured to be a tube of the laminated structure. The rubber hose 10 having the configuration described above is fit for circulating high-pressure hydraulic fluids in a hydraulic system or, in other words, for use as a high-pressure hydraulic hose.

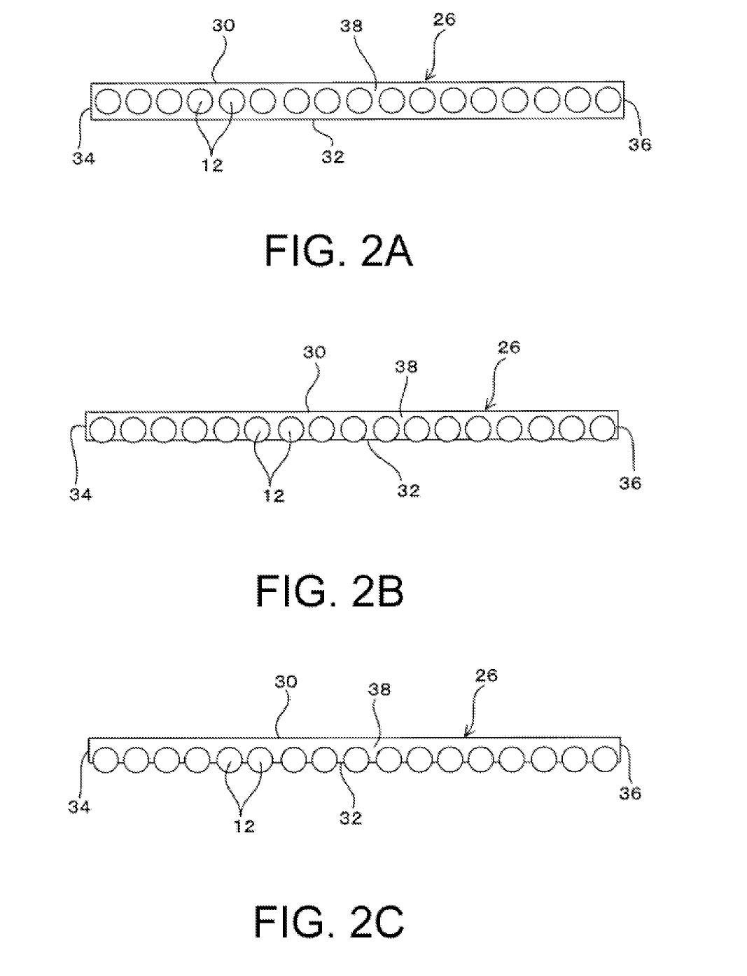

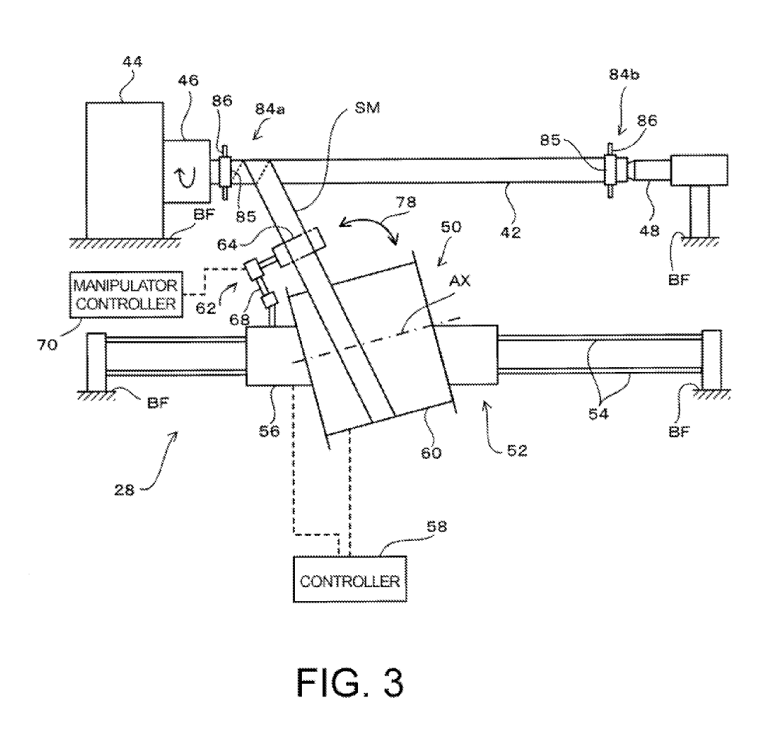

The rubber hose 10 described above can be preferably manufactured by a method for manufacturing a rubber hose according to an embodiment of the present technology described hereinafter. Additionally, the method for manufacturing a rubber hose can be preferably carried out by using a composite strip material 26 illustrated in the specific examples illustrated in FIGS. 2A to 2C and using a strip material helical winding device 28 illustrated in the specific example illustrated in FIG. 3. First, the composite strip material 26 and the strip material helical winding device 28 will be described.

The three specific examples of the composite strip material 26 illustrated as cross-sectional views in FIGS. 2A to 2C have opposite side surfaces 30, 32 and opposite side edges 34, 36. Each composite strip material 26 includes an unvulcanized rubber strip 38 and a plurality of the reinforcing steel cords 12 provided in the unvulcanized rubber strip 38 so as to be arranged in a mutually juxtaposed manner and extend in a longitudinal direction of the unvulcanized rubber strip 38 (and therefore, in the longitudinal direction of the composite strip material 26). The plurality of the steel cords 12 is arranged in a single line in the same plane extending parallel with the side surfaces 30, 32 of the composite strip material 26. The steel cords 12 have flexibility and also high tensile rigidity, and, as stated above, function as a reinforcing material of the rubber hose 10.

With the composite strip material 26 of FIG. 2A, an entirety of each of the steel cords 12 is embedded completely in an unvulcanized rubber strip 36. With the composite strip materials 26 of FIGS. 2B and 2C, a portion of a circumferential surface of each of the steel cords 12 is embedded in the unvulcanized rubber strip 36 and a remaining portion of the circumferential surface is exposed from a first side surface 32 of the unvulcanized rubber strip 36. Particularly, with the composite strip material 26 of FIG. 2C, compared to the composite strip material of FIG. 2B, a greater portion of each of the steel cords 12 is exposed; specifically, a semicircular portion of the circumferential surface of each of the steel cords 12 is embedded in the unvulcanized rubber strip 36, and a remaining semicircular portion of the circumferential surface is exposed from the first side surface 32 of the unvulcanized rubber strip 36. The surfaces (circumferential surfaces) of the steel cords 12 are preferably brass plated for reasons that will be described below.

FIG. 3 is a schematic view illustrating a plan view of an arrangement of the main components of the strip material helical winding device 28. The illustrated strip material helical winding device 28 is provided with a base frame (schematically illustrated and referred to as “BF” in the figure), a mandrel 42 that is rotatably supported by the base frame BF and that can wind a strip material SM (i.e. composite strip material 26, etc.) therearound, and a mandrel drive mechanism that drives and rotates the mandrel 42. The mandrel drive mechanism is formed from a rotating drive head 44 that is provided with a chuck 46 for gripping an end of the mandrel 42. The strip material helical winding device 28 is further provided with a tailstock 48 that engages with another end of the mandrel 42. The rotating drive head 44 and the tailstock 48 are attached to the base frame BF, and the mandrel 42 is rotatably supported by the base frame BF, with a longitudinal axial center being the center thereof, via the rotating drive head 44 and the tailstock 48. The mandrel 42 can be removed from the base frame BF by operating the chuck 46 and the tailstock 48.

The strip material helical winding device 28 is further provided with a strip material supplier 50, which is a mechanism for supplying the strip material SM that will be wound around the mandrel 42 toward the mandrel 42, and a feeding mechanism 52 for feeding the strip material supplier 50 along the mandrel 42. The feeding mechanism 52 includes a pair of guide rails 54 that is fixed to the base frame BF, and the guide rails 54 are disposed so that the mandrel 42 that is supported by the rotating drive head 44 and the tailstock 48 extends in parallel with the guide rails 54. The feeding mechanism 52 further includes a carriage 56, and the carriage 56 is provided with a running mechanism and is runnable on the guide rails 54. The strip material supplier 50 is mounted on the carriage 56.

The strip material helical winding device 28 is further provided with a controller 58 that can individually or conjunctively control the rotating drive head 44 that is the mandrel drive mechanism and the feeding mechanism 52. By conjunctively controlling the rotating drive head 44 and the feeding mechanism 52, the controller 58 can feed the strip material supplier 50 along the mandrel 42 synchronously with the rotation of the mandrel 42.

The strip material supplier 50 is provided with a drum 60 and a guide mechanism 62. The drum 60 has a axial center AX and is rotatably supported by the carriage 56 around the axial center AX. The strip material SM is wound around the drum 60 and stored. Thus, the drum 60 is a strip material storing mechanism that stores the strip material SM supplied toward the mandrel 42. Likewise, the guide mechanism 62 is also supported by the same carriage 56, and the guide mechanism 62 is a mechanism that guides the strip material SM that is unwound from the drum 60 and supplied toward the mandrel 42 by being picked up and pulled by the mandrel 42.

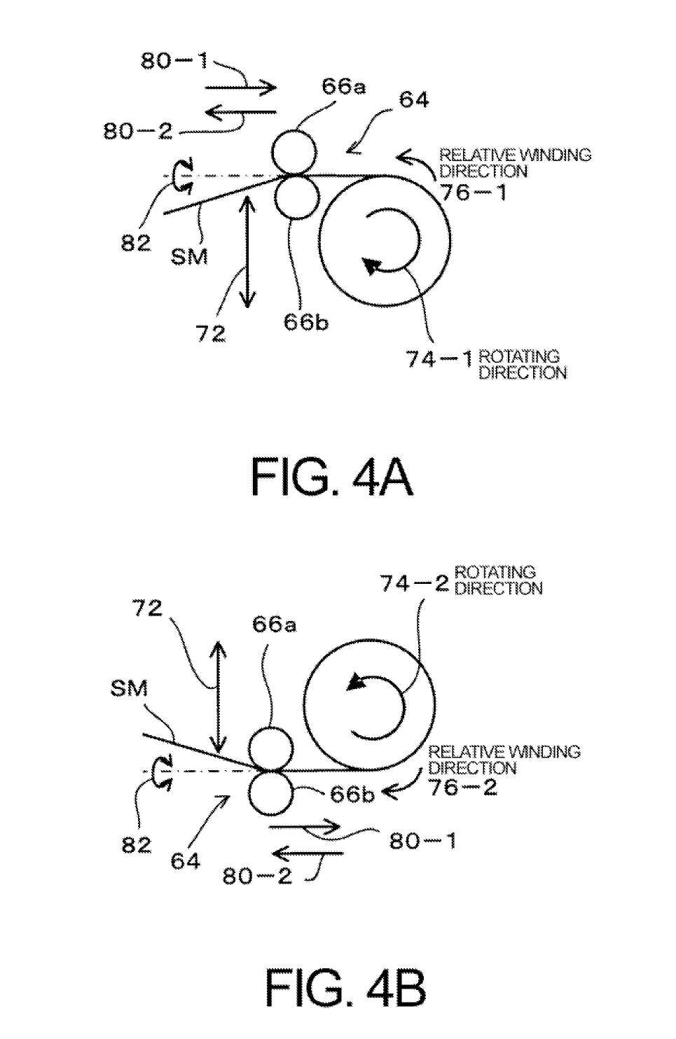

The guide mechanism 62 is provided with a guide head 64. The strip material SM that is unwound from the drum 60 and supplied toward the mandrel 42 passes through the guide head 64 and is gripped and guided by the guide head 64. As illustrated in FIGS. 4A and 4B, a pair of guide rollers 66a, 66b is housed inside of the guide head 64, and the guide rollers 66a, 66b are arranged so as to be abutted against the opposite side surfaces of the strip material SM, and sandwich and grip the strip material SM. The guide mechanism 62 is further provided with a manipulator 68 formed from a robotic arm having multiple degrees of freedom that can control a position and an orientation of the guide head 64, and a controller 70 for controlling the manipulator 68. The manipulator 68 can move the guide head 64 in a vertical direction as indicated by the arrow 72. Thereby, the strip material helical winding device 28 is configured so as to be able to supply the strip material SM to a first side of the mandrel 42 (top side in the illustrated example) as illustrated in FIG. 4A, and supply the strip material SM to a second side of the mandrel 42 (bottom side in the illustrated example), opposite the first side, as illustrated in FIG. 4B. When the mandrel 42 is rotating in a rotating direction indicated by the arrow 74-1 in FIG. 4A, the strip material SM is supplied to the top side of the mandrel 42. As indicated by the arrow 76-1, a relative winding direction of the strip material SM with respect to the mandrel 42 at this time is a direction opposite the rotating direction 74-1 of the mandrel 42. On the other hand, when the mandrel 42 is rotating in a rotating direction indicated by the arrow 74-2 in FIG. 4B (direction opposite the rotating direction 74-1), the strip material SM is supplied to the bottom side of the mandrel 42. As indicated by the arrow 76-2, a relative winding direction of the strip material SM with respect to the mandrel 42 at this time is a direction opposite the rotating direction 74-2 of the mandrel 42.

Furthermore, the manipulator 68 can steer the guide head 64 in a horizontal direction as indicated by the arrow 78 in FIG. 3; can move the guide head 64 in directions approaching to and moving away from the mandrel 42 as indicated by the arrows 80-1 and 80-2 in FIGS. 4A and 4B; and can rotate the guide head 64 so as to vertically invert the guide head 64 as indicated by the arrow 82 in FIGS. 4A and 4B. By vertically inverting the guide head 64, the side surface of the opposite side surfaces of the strip material SM that is opposite the circumferential surface of the mandrel 42 can be alternated.

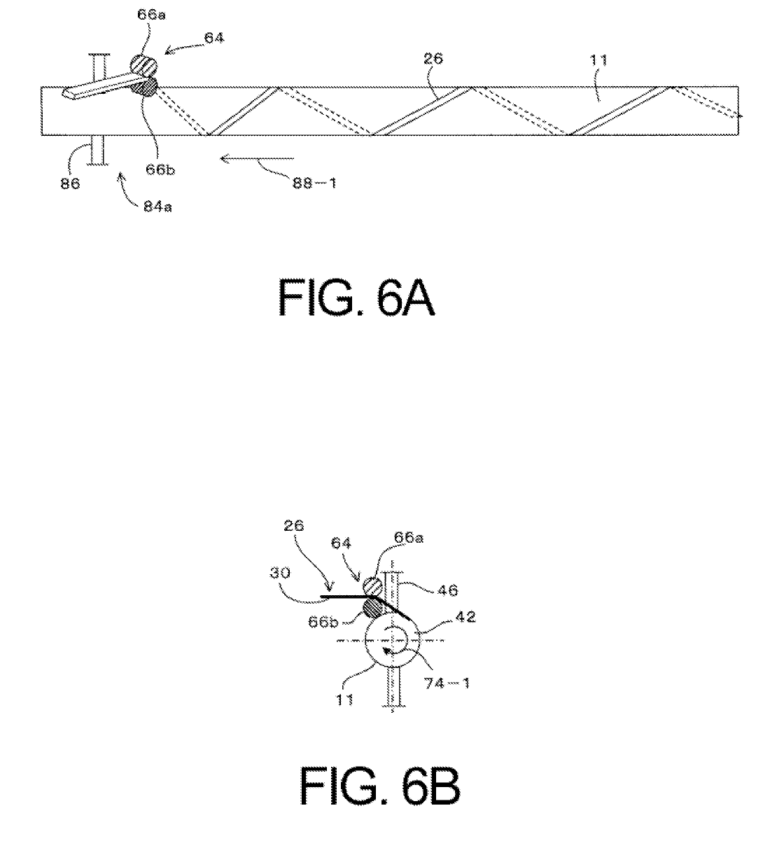

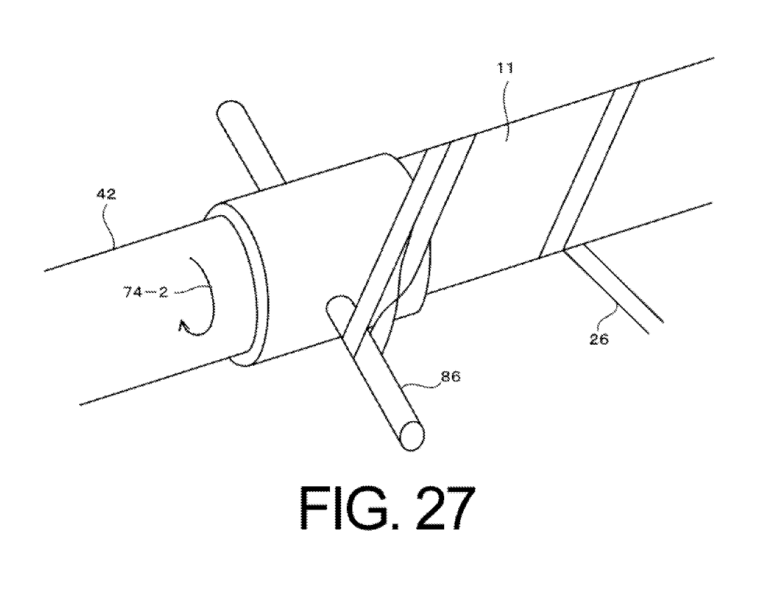

Furthermore, the manipulator 68 has the ability to change the position in three dimensional space and the three-dimensional orientation of the guide head 64 with greater complexity. This ability is used in a reversing process in the wrapping process of the composite strip material, and this process is described in detail hereinafter while referring to FIG. 6 to FIG. 33.

The mandrel 42 is provided with a pair of latching members 84a, 84b for hooking and latching the strip material SM thereon, and the latching members 84a, 84b are attached respectively to both ends of the mandrel 42. The latching members 84a, 84b are each constituted by a sleeve 85 that interlocks with a periphery of the mandrel 42 and a pair of pins 86 protruding from the sleeve 85 in the radial direction, in mutually opposing directions. When the reversing process in the wrapping process of the strip material SM is performed, the strip material SM is hooked and latched to the pins 86 by the guide mechanism 62. The method in which this is performed is described in detail in the following description of the method for manufacturing a rubber hose according to an embodiment of the present technology. Furthermore, in the following description, a method of forming the laminated reinforcing layer 14 using the strip material helical winding device 28 having the configuration described above will be described.

The method for manufacturing a rubber hose according to an embodiment of the present technology includes a step of fabricating the composite strip material 26. As described previously referencing FIGS. 2A to 2C, the composite strip material 26 has the opposite side surfaces 30, 32 and the opposite side edges 34, 36, and is formed from a unvulcanized rubber strip 38 and a plurality of reinforcing steel cords 12 provided in the unvulcanized rubber strip so as to be arranged in a mutually juxtaposed manner and extend in a longitudinal direction of the unvulcanized rubber strip. In order to fabricate the composite strip material 26, for example, unvulcanized rubber is molded into a strip shape and, simultaneously, a plurality of steel cords is completely or partially embedded in the unvulcanized rubber strip as inserts. The fabricated composite strip material 26 is wound around the drum 60 of the strip material supplier 50 and stored in the drum 60.

The method for manufacturing a rubber hose further includes a step of fabricating the flexible inner tube 11 that forms the innermost layer of the rubber hose 10. The inner tube 11 may be formed using a conventional method for manufacturing a rubber tube, and in this case, the formed inner tube 11 is cut so as to match a length of the rubber hose to be fabricated and engaged on the periphery of the mandrel 42. As an alternate method, the inner tube 11 may be formed by helically winding the unvulcanized rubber strip on a periphery of the mandrel 42, and, at a later time, vulcanizing the wound unvulcanized rubber strip. In either case, it is beneficial to apply, as necessary, an appropriate release agent to an inner surface of the inner tube 11 and/or an outer surface of the mandrel so that following completion of the rubber hose, the inner tube 11 can be removed from the mandrel.

The method for manufacturing a rubber hose further includes a step of forming a laminated reinforcing layer 14 provided with a plurality of helically arranged steel cords 12 around the inner tube 11. In this step, a wound body having a laminated structure is formed by winding the composite strip material 26 around the inner tube 11 and laminating a plurality of unit layers 90 to 96 on each other (see FIG. 1B). At that point, one of the unit layers is formed on (around) the inner tube 11, and yet another of the unit layers is formed subsequently on (around) said formed unit layer. Thereafter, the unvulcanized rubber strip 38 of the wound composite strip material 26 is vulcanized.

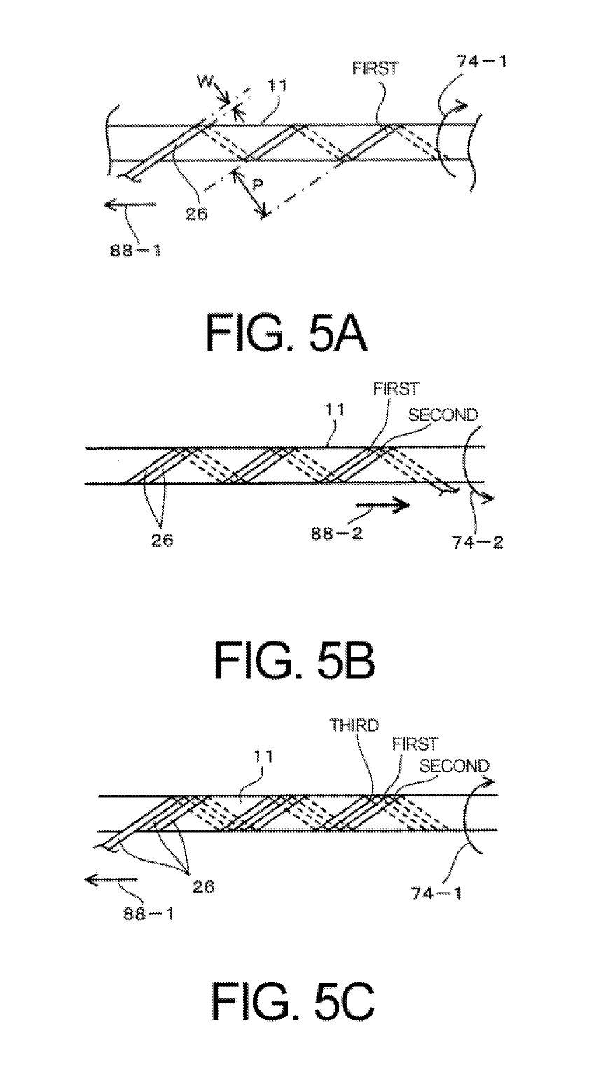

More specifically, as illustrated in FIGS. 5A to 5C, an end of the composite strip material 26 unwound from the drum 60 is attached to an end (the right end in FIG. 5A) of the inner tube 11 that is loaded on the periphery of the mandrel 42 of the strip material helical winding device 28. Then the strip material helical winding device 28 is activated and, as illustrated in FIG. 5A, feeds the carriage 56 in a first feeding direction, indicated by the arrow 88-1, along the guide rails 52 while rotating the mandrel 42 in the first rotating direction indicated by the arrow 74-1. Thereby, the composite strip material 26 is helically wound on the periphery of the inner tube 11. Here, the first side surface of the composite strip material 26 is abutted against the peripheral surface of the inner tube 11, and the composite strip material 26 is helically wound in a given helix direction, at a given helix angle, and at a given pitch P. Particularly, the pitch P of the helix is larger than a width dimension W of the composite strip material 26, and N times the width dimension W (where N is an integer greater than or equal to 2).

The size of the helix angle is a factor that is determined as desired by the designer of the rubber hose 10 depending on the performance conditions required of the rubber hose 10. A value of the integer N is a factor that is determined as desired by the designer based mainly on the degree the flexural rigidity of the mandrel 42 and the amount of tension acting on the composite strip material 26 when the composite strip material 26 is wound around the inner tube 11 (and therefore around the mandrel 42). The helix direction is a factor determined by the relative winding direction of the composite strip material 26 with respect to the mandrel 42 (the direction opposite the rotating direction of the mandrel 42) and the feed direction of the carriage 56 (the winding forward direction of the composite strip material 26).

As described above, a first winding pass forming step is performed, and at the end of the first winding pass forming step, the composite strip material 26 is hooked and latched onto the latching member 84a (see FIG. 3) that is provided on the left end of the mandrel 42. The composite strip material 26 is latched in this way because an entirety of one of the unit layers, or, in some cases, a plurality of the unit layers is formed from the composite strip material 26 having a single continuous form, which will be described hereinafter.

Next, as illustrated in FIG. 5B, the carriage 56 is fed in a second feeding direction, indicated by the arrow 88-2 (the direction opposite the first feeding direction), along the guide rails 52 while rotating the mandrel 42 in a second rotating direction (the direction opposite the first rotating direction) indicated by the arrow 74-2. Thereby, the composite strip material 26 is helically wound on the periphery of the inner tube 11. This is a second winding pass forming step. Here, the first side surface of the composite strip material 26 is abutted against the peripheral surface of the inner tube 11, and the composite strip material 26 is helically wound in a helix direction, at a helix angle, and at a pitch that are identical to the helix direction, the helix angle, and the pitch P in the first winding pass forming step. Then, the side edges with respect to the wound composite strip material 26 of the first winding pass are brought into close contact and the composite strip material 26 of the second winding pass is wound anew. Next, at the end of the second winding pass forming step, the composite strip material 26 is hooked and latched onto the latching member 84b (see FIG. 3) that is provided on the right end of the mandrel 42.

Next, as illustrated in FIG. 5C, by feeding the carriage 56 in the second feeding direction 88-2 while rotating the mandrel 42 again in the first rotating direction 74-1, a third winding pass forming step is performed. Here as well, the helix direction, the helix angle, and the pitch are identical to those of the first and second winding pass forming steps. Then, the side edges with respect to the wound composite strip material 26 of the first winding pass are brought into close contact and the composite strip material 26 of the third winding pass is wound anew. Note that the composite strip material 26 of the third winding pass is wound along the side edge of the opposite side edges of the composite strip material 26 of the first winding pass of the side opposite the side edge that the composite strip material 26 of the second winding pass was wound along.

Hereinafter, in the same way, the winding pass forming step is repeated N times while alternately switching the feeding direction of the carriage 56 (the winding forward direction of the composite strip material 26) between the first feeding direction and the second feeding direction. By repeated performance thereof, the composite strip material 26 of a fourth winding pass is wound so that the side edges are brought into close contact with respect to the composite strip material 26 of the wound second winding pass; the composite strip material 26 of a fifth winding pass is wound so that the side edges are brought into close contact with respect to the composite strip material 26 of the wound third winding pass; and ultimately, the peripheral surface of the inner tube 11 is completely covered by N winding passes of the composite strip material 26, and, thereby a first (innermost layer) unit layer 90 (see FIG. 1B) is formed on (around) the inner tube 11.

Next, a second unit layer 92 is formed on (around) the first unit layer 90 via the same procedure used in forming the first unit layer 90. However, in the illustrated example, while the helix direction of the composite strip material 26 of the first unit layer 90 is set to be the first helix direction, the helix direction of the composite strip material 26 of the second unit layer 92 is set to be the second helix direction, the direction opposite the first helix direction. Additionally, in the same way, a third unit layer 94 is formed on (around) the second unit layer 92 and a fourth unit layer 96 is formed on (around) the third unit layer 94. However, the unit layers 90 to 96 are formed by alternately laminating a unit layer formed by winding the composite strip material 26 in the first helix direction and a unit layer formed by winding the composite strip material 26 in the second helix direction.

With the first unit layer 90, while the base peripheral surface upon which the unit layer 90 is formed is the peripheral surface of the inner tube 11, with the second unit layer 92, the third unit layer 94, and the fourth unit layer 96, the base peripheral surface upon which said unit layers are formed is the peripheral surface of the unit layer formed therebefore. However, this has no effect on the order in which the unit layers are formed. The following is a summary of the process described above for forming the laminated reinforcing layer 14 around the inner tube 11: when forming each of the unit layers, the first side surface of the composite strip material 26 is abutted against a base peripheral surface upon which the unit layer is formed, and a side edge of the composite strip material 26 forming one turn of the helix and a side edge of the composite strip material forming the turn adjacent thereto are brought into close contact, and the composite strip material 26 is helically wound on the base peripheral surface. Thereby, the base peripheral surface is covered by the composite strip material 26. Furthermore, each of the unit layers is formed by alternately repeating a winding pass forming step in a first winding forward direction for helically winding the composite strip material 26 in a first direction of the longitudinal direction of the base peripheral surface in a given helix direction, at a given helix angle, and at a given pitch P that is N times a width dimension of the composite strip material 26 (where N is an integer greater than or equal to 2); and a winding pass forming step in a second winding forward direction for winding the composite strip material in a second direction that is a direction opposite the first direction of the longitudinal direction of the base peripheral surface in the given helix direction, at the given helix angle, and at the given pitch.

Furthermore, as described above, in the method for manufacturing a rubber hose, the composite strip material 26 having a single continuous form is used to form each of the unit layers. Specifically, the composite strip material 26 having a single continuous form is wound on the base peripheral surface to perform the first winding pass forming step to an Nth winding pass forming step for forming each of the unit layers. In order to make this possible, a reversing process for reversing the winding forward direction is interposed between two continuous winding pass forming steps. In the reversing process, the manipulator 68 of the strip material supplier 50 operates the guide head 64 so as to hook and latch the composite strip material 26 on the latching members 84a, 84b of both ends of the mandrel 42, and this is discussed below in detail.

FIGS. 6 to 20 are a series of drawings illustrating each step of the reversing process in the wrapping process of the composite strip material 26 for forming the first unit layer 90 described above, and schematically illustrate a front view and a side view of the mandrel 42 and the guide head 64. Note that the presence of the guide head 64 is expressed by illustrating the guide rollers 66a, 66b housed therein.

FIGS. 6A and 6B illustrate a stage immediately prior to the completion of the first winding pass forming step among the multiple winding pass forming steps performed to form the first unit layer 90 (see FIG. 1B); of the pair of guide rollers 66a, 66b in the guide head 64, the guide roller 66a is positioned above the guide roller 66b and the composite strip material 26 sandwiched between the guide rollers is supplied to the top side of the mandrel 42. The first side surface 30 of the composite strip material 26 is abutted against the peripheral surface of the inner tube 11 on the mandrel 42. The mandrel 42 rotates in the first rotating direction 74-1 in order to pick up the composite strip material 26 supplied to the top side of the mandrel 42. Additionally, the carriage 56 (see FIG. 3) is fed in the first feeding direction 88-1, and the guide head 64 moves along with the carriage 56. Thereby, the composite strip material 26 is wound forward in the first winding forward direction 88-1.

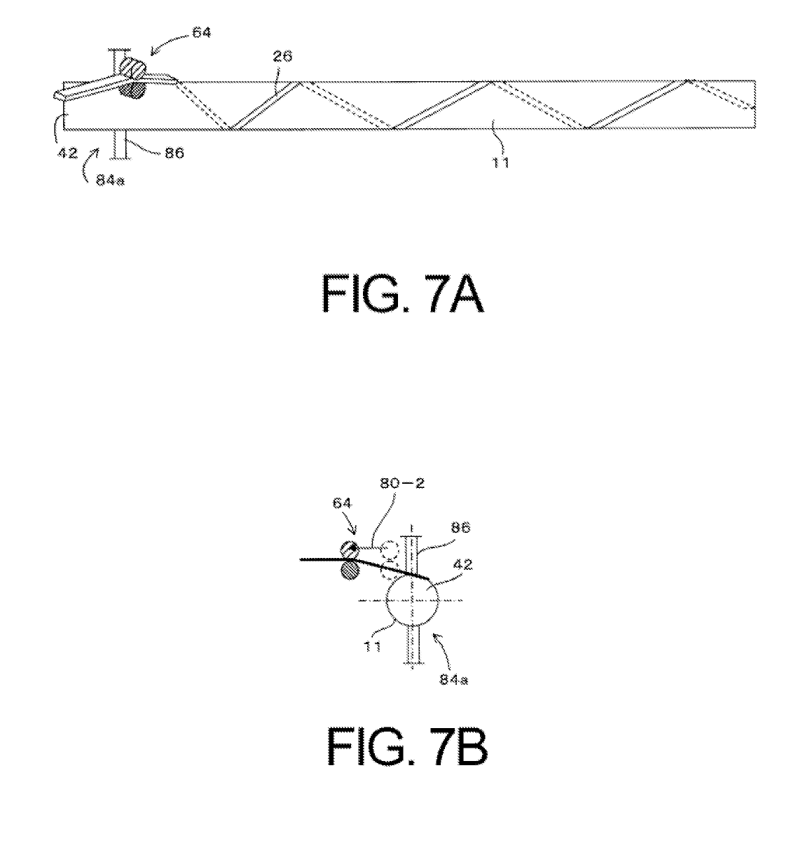

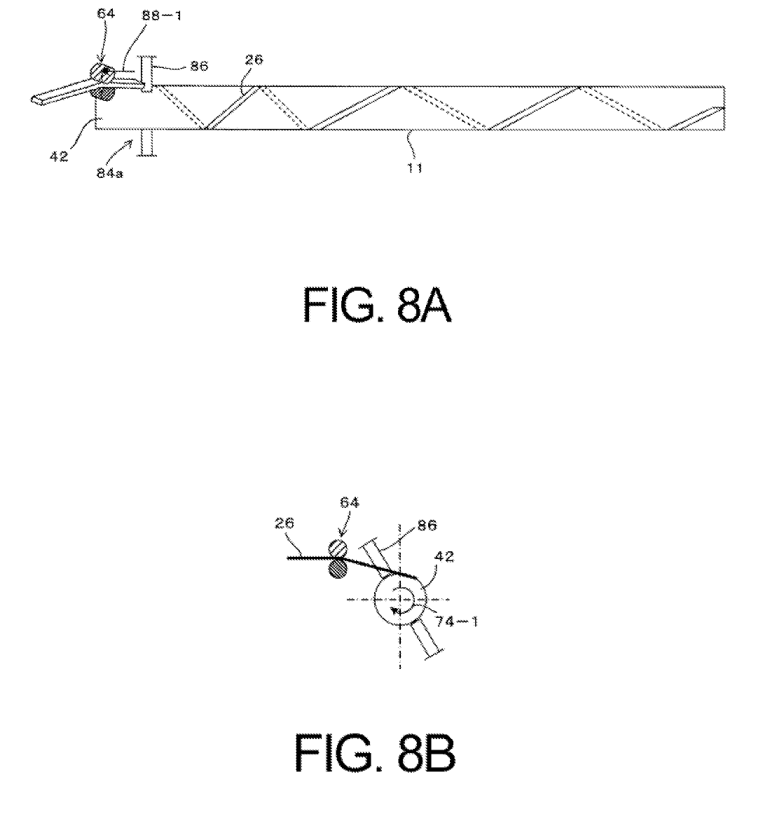

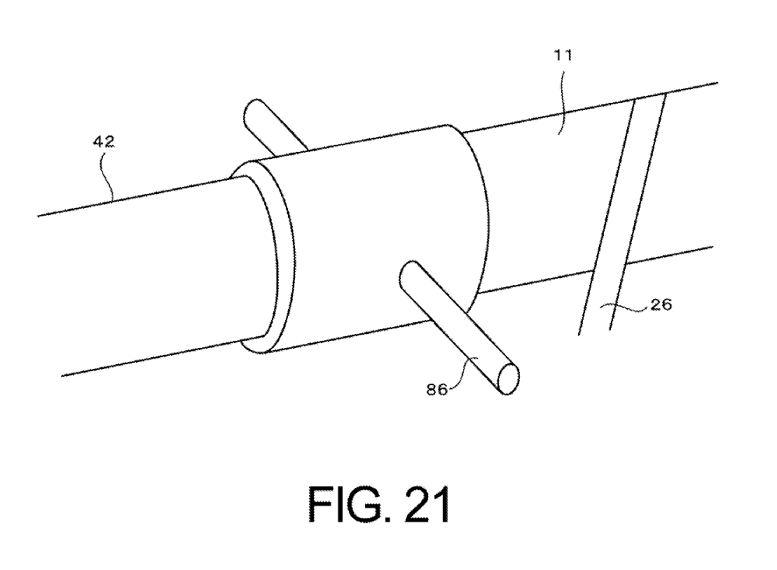

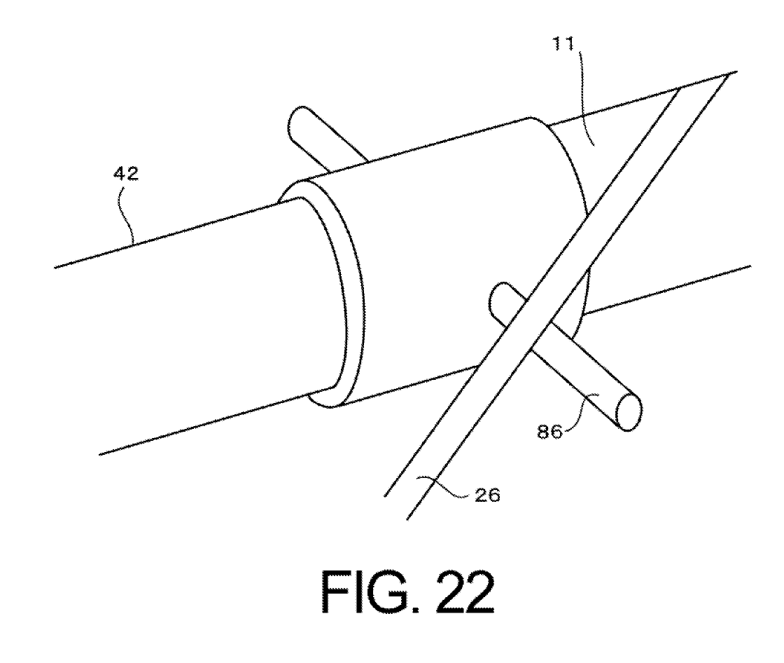

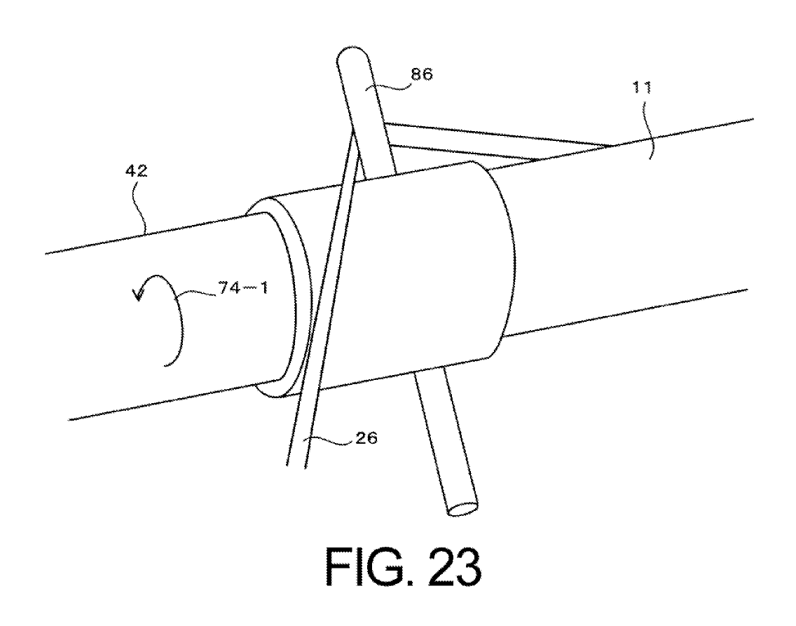

As illustrated in FIGS. 7A, 7B, and 21, when the composite strip material 26 has been wound forward to immediately before the latching member 84a, the winding is stopped by stopping the rotation of the mandrel 42 and stopping the feeding of the carriage 56. Then, the guide head 64 is moved in a direction away from the mandrel 42 as indicated by the arrow 80-2 in FIG. 7B. Next, as illustrated in FIG. 8A, the guide head 64 is moved just an adequate distance in the first feeding direction 88-1 so as to pass beside the latching member 84a. Thereafter, following the state illustrated in FIG. 22, by rotating the mandrel 42 just an appropriate degree in the first rotating direction 74-1, the composite strip material 26 is hooked and latched onto one of the pins 86 of the latching member 84a as illustrated in FIGS. 8B and 23.

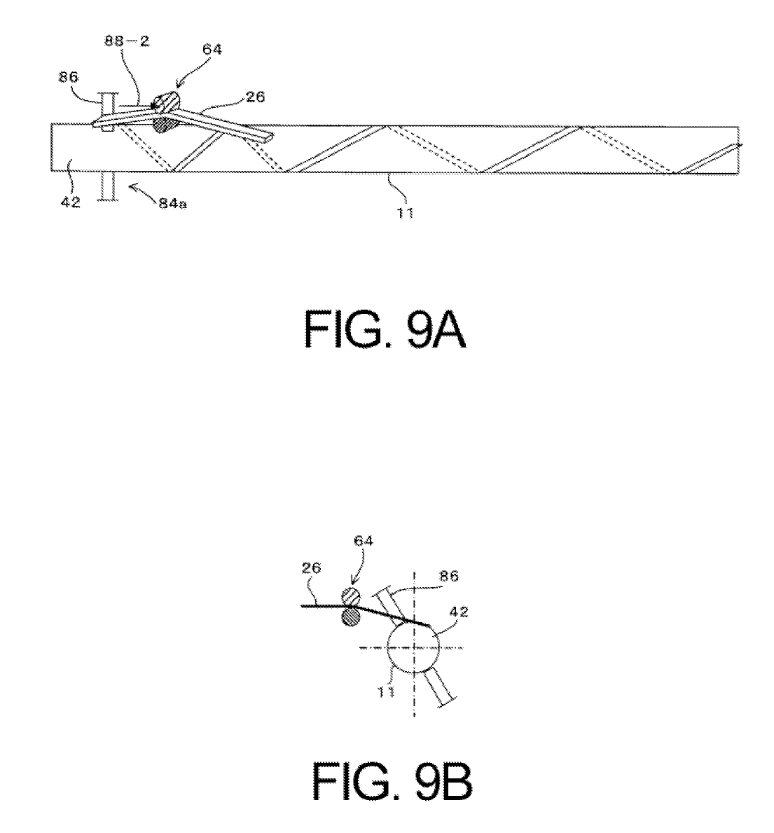

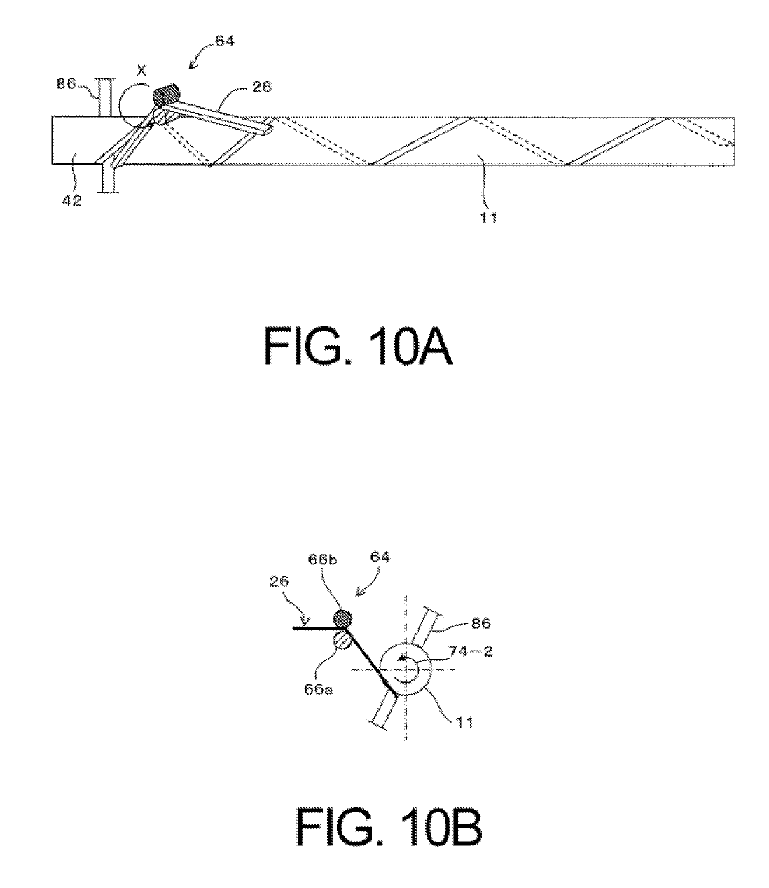

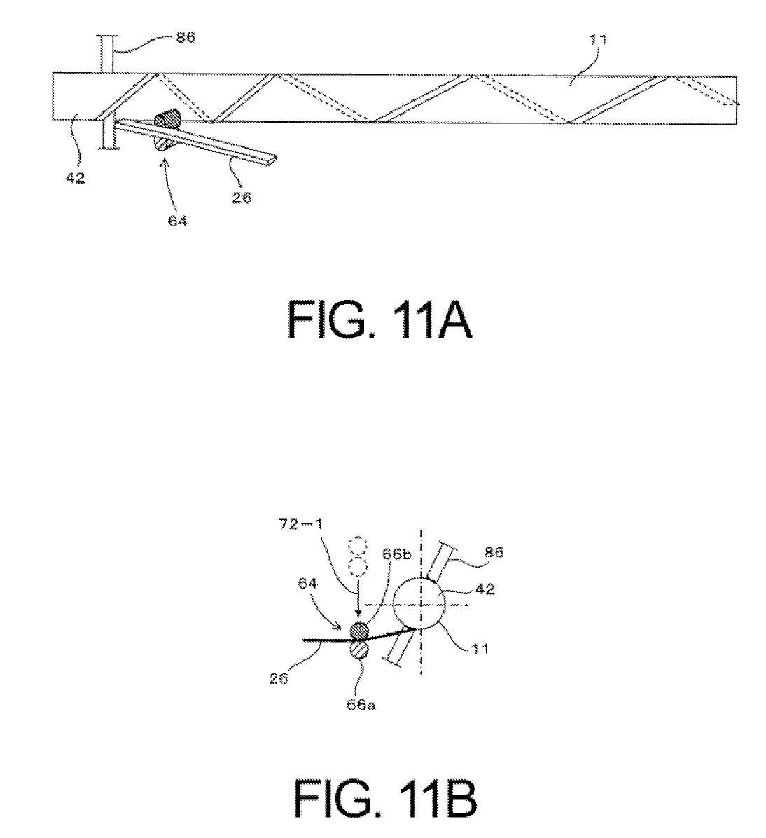

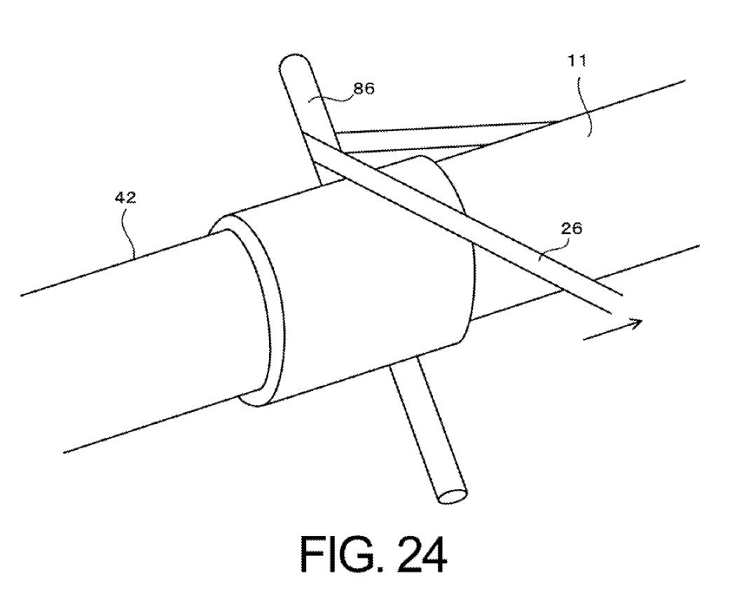

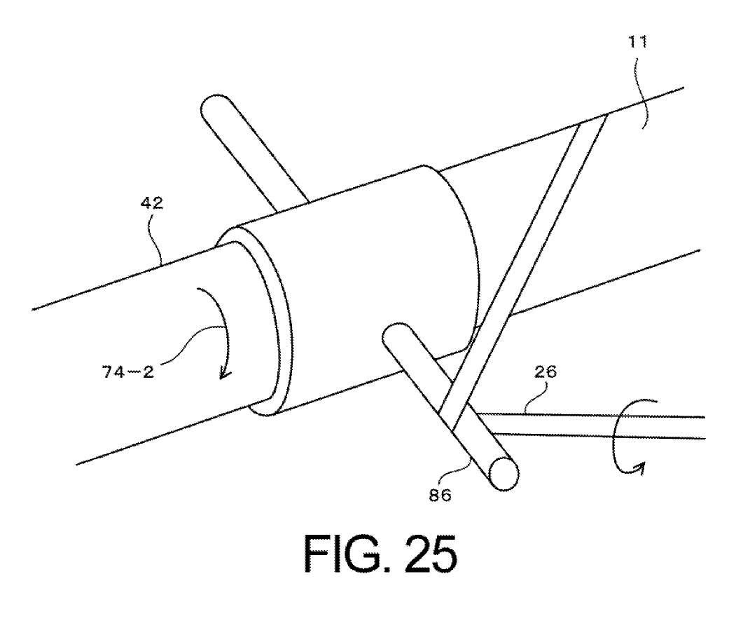

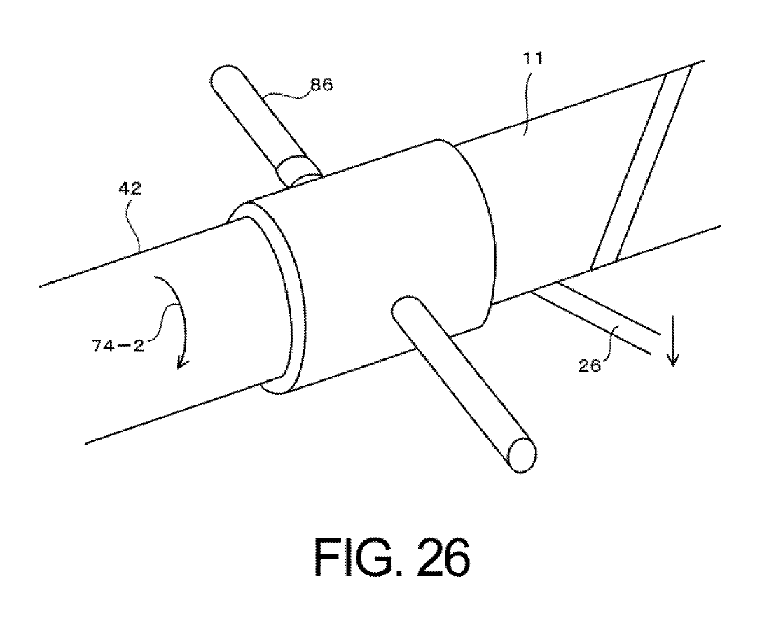

Next, as illustrated in FIGS. 9A, 9B, and 24 the guide head 64 is moved just an adequate distance in the second feeding direction 88-2 so as to pass beside the latching member 84a. Thereafter, as illustrated in FIGS. 10A, 10B, and 25, the mandrel 42 is rotated just an adequate degree in the second rotating direction 74-2, and, simultaneously, the guide head 64 is rotated as illustrated in FIG. 10A; specifically, as indicated by the arrow X in FIG. 10A, the guide head 64 is vertically inverted by rotating the guide head 64 180 degrees counterclockwise (when viewed in a direction towards the mandrel 42) around the axial center extending in the longitudinal direction of a portion of the composite strip material 26 extending between the mandrel 42 and the guide head 64. Thereby, the portion of the composite strip material 26 extending between the mandrel 42 and the guide head 64 is provided with a 180 degree twist. Next, as illustrated in FIGS. 11A, 11B, and 26, when the guide head 64 is lowered as indicated by the arrow 72-1 while adequately rotating the mandrel 42 in the second rotating direction, a state where the composite strip material 26 is supplied to a bottom side of the mandrel 42 is obtained.

Thus, by rotating and vertically inverting the guide head 64 that grips and guides the composite strip material 26, the composite strip material 26 becomes twisted. Therefore, the directions that the opposite side surfaces of the composite strip material 26 supplied toward the mandrel 42 face are alternated between upward-facing and downward-facing. When the composite strip material 26 is hooked and latched onto the latching member 84a, the side surface 30 of the composite strip material 26 that was abutted against the peripheral surface of the inner tube 11 in the first winding pass forming step is abutted against the circumferential surface of the pin 86 of the latching member 84a. Thereafter, when the composite strip material 26 is supplied to the bottom side of the mandrel 42 the side surface 30 of the composite strip material 26 is abutted against the peripheral surface of the inner tube 11 again.

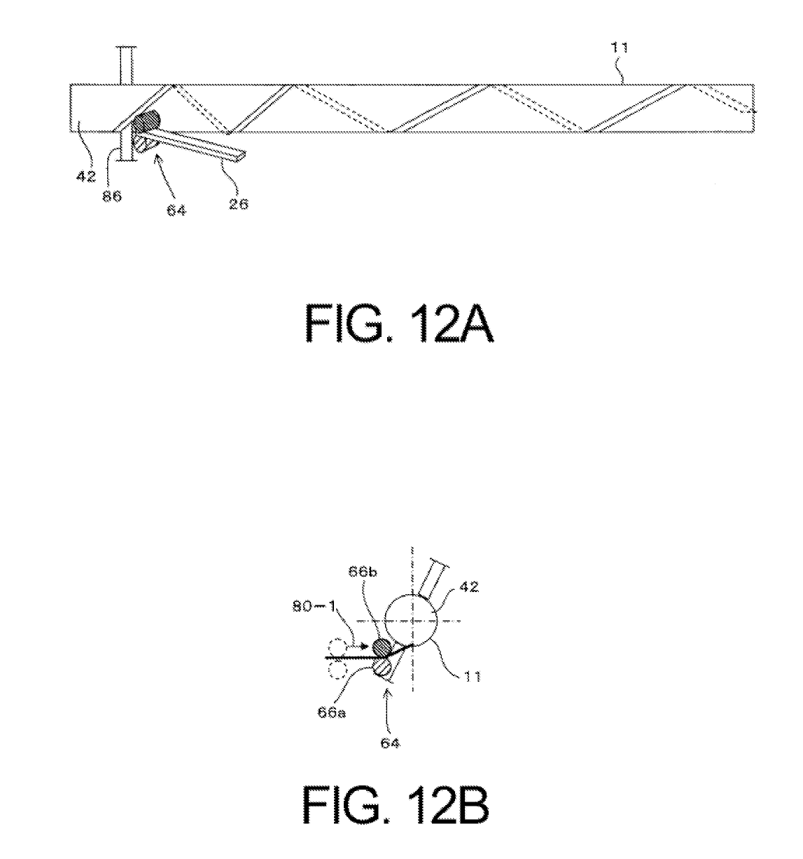

Next, as illustrated in FIGS. 12A and 12B, the guide head 64 is moved in a direction 80-1 so as to approach the mandrel 42. From here, the second winding pass forming step of the plurality of winding pass forming steps performed to form the first unit layer 90 begins.

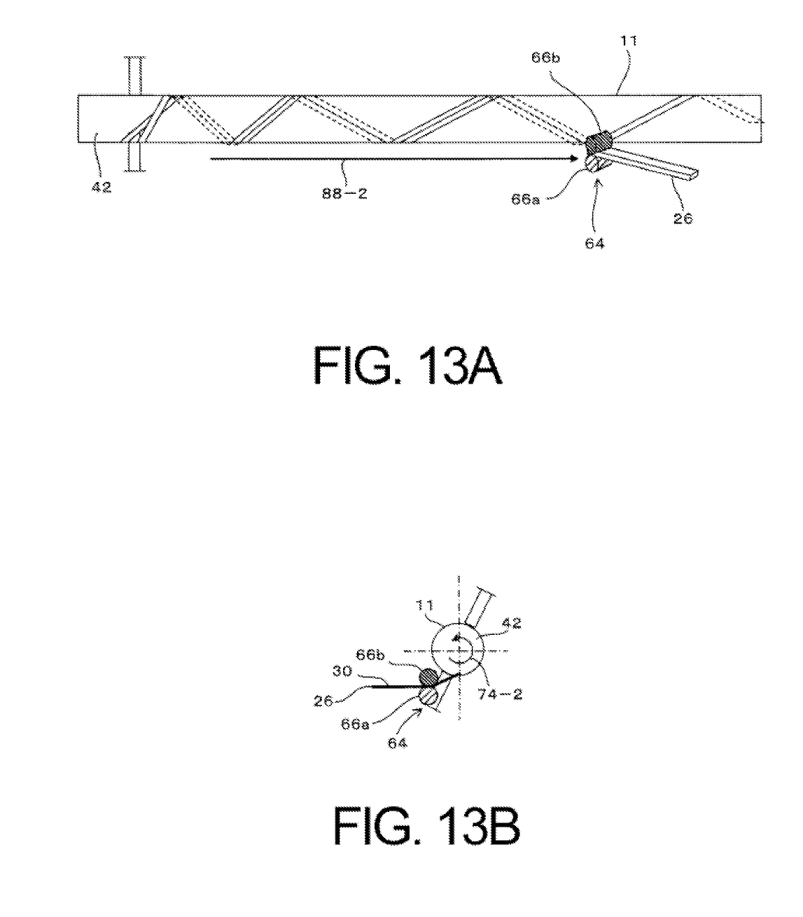

When performing the second winding pass forming step, as illustrated in FIGS. 13A and 13B, the pair of guide rollers 66a, 66b housed in the guide head 64 are arranged so that the guide roller 66a is below the guide roller 66b, opposite the arrangement in the first winding pass forming step. The composite strip material 26 sandwiched between the guide rollers is supplied to the bottom side of the mandrel 42. However, the side surface 30 of the composite strip material 26 is abutted against the peripheral surface of the inner tube 11 on the mandrel 42, the same as in the first winding pass forming step. The mandrel 42 rotates in the second rotating direction 74-2 so as to be able pick up the composite strip material 26 supplied to the bottom side of the mandrel 42. Additionally, the carriage 56 is fed in the second feeding direction 88-2, and the guide head 64 moves along with the carriage 56. Thereby, the composite strip material 26 is wound forward in the second winding forward direction 88-2.

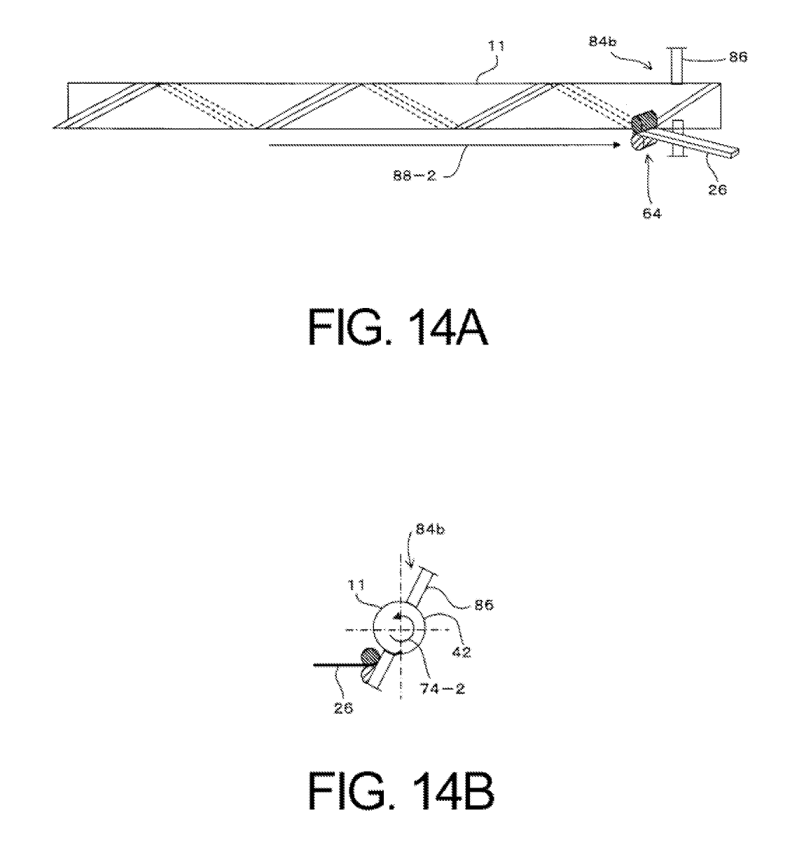

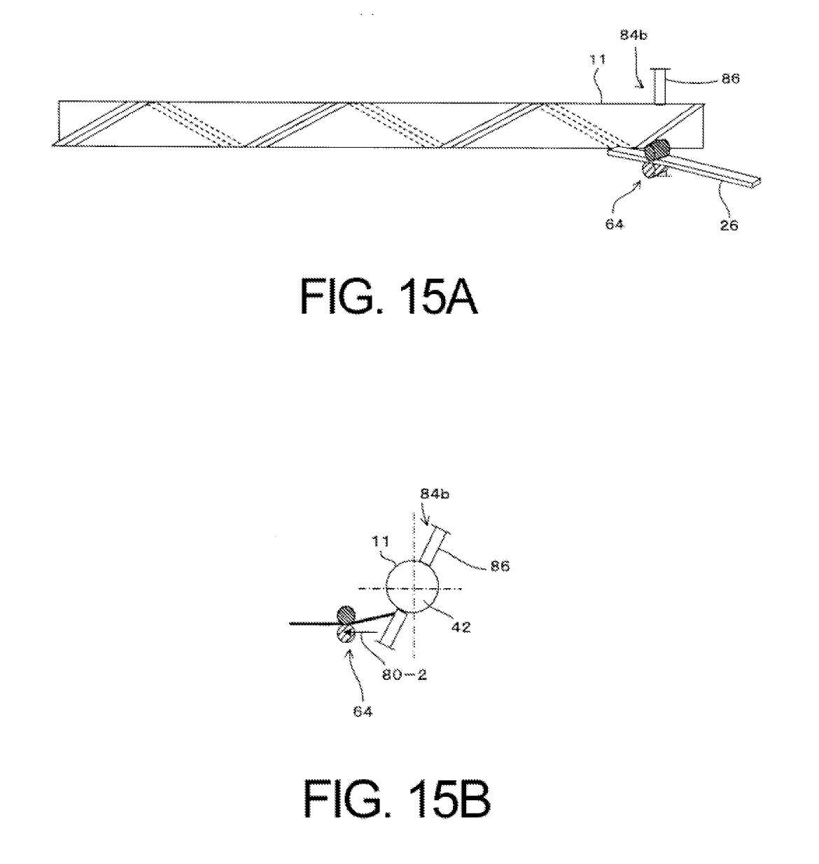

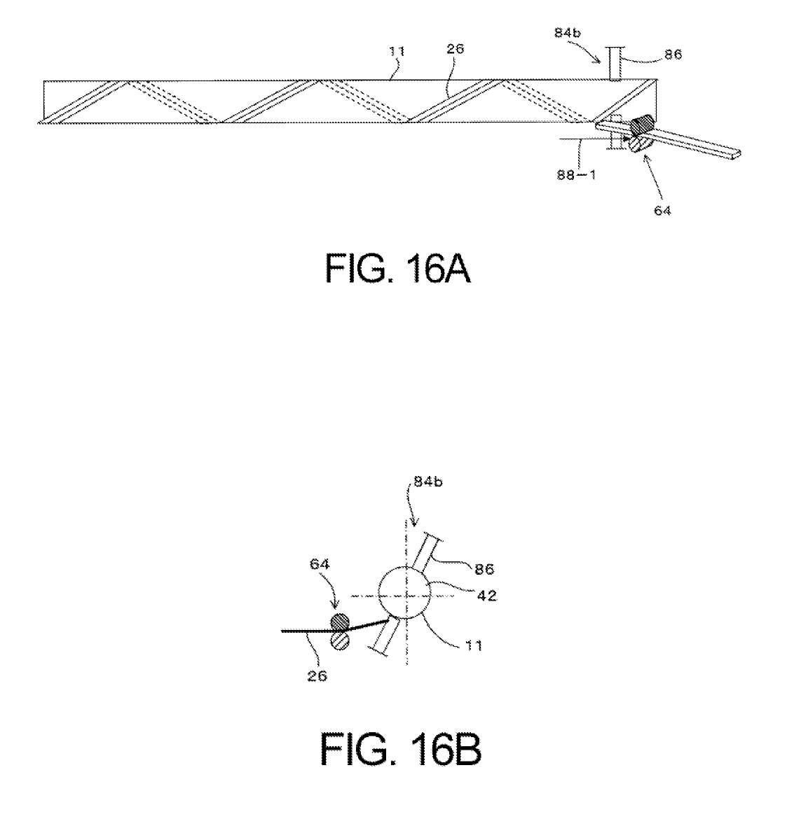

As illustrated in FIGS. 14A and 14B, when the composite strip material 26 has been wound forward to immediately before the other latching member 84b, the winding is stopped by stopping the rotation of the mandrel 42 and stopping the feeding of the carriage 56. Then, the guide head 64 is moved in a direction away from the mandrel 42 as indicated by the arrow 80-2 in FIG. 15B. Next, as illustrated in FIG. 16A, the guide head 64 is moved just an adequate distance in the second feeding direction 88-2 so as to pass beside the latching member 84b.

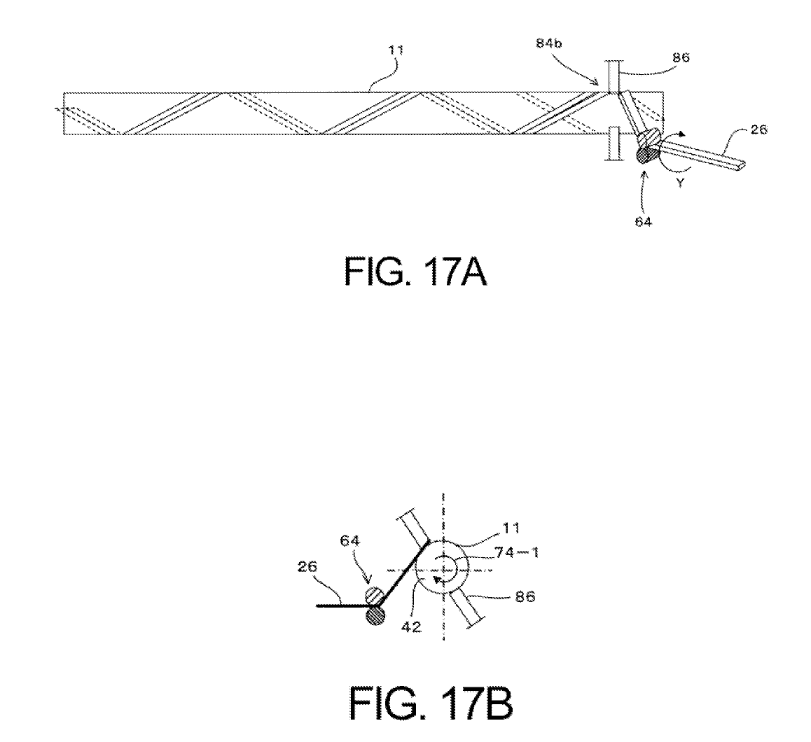

Thereafter, the guide head 64 is rotated as illustrated in FIG. 17A, and specifically, as indicated by the arrow Y in FIG. 17A, the guide head 64 is vertically inverted by rotating the guide head 64 180 degrees clockwise (when viewed in a direction towards the mandrel 42) around the axial center extending in the longitudinal direction of a portion of the composite strip material 26 extending between the mandrel 42 and the guide head 64. Thereby, the portion of the composite strip material 26 extending between the mandrel 42 and the guide head 64 is provided with a 180 degree twist. Thereafter, by rotating the mandrel 42 just an appropriate degree in the first rotating direction 74-1, the composite strip material 26 is hooked and latched onto one of the pins 86 of the latching member 84b.

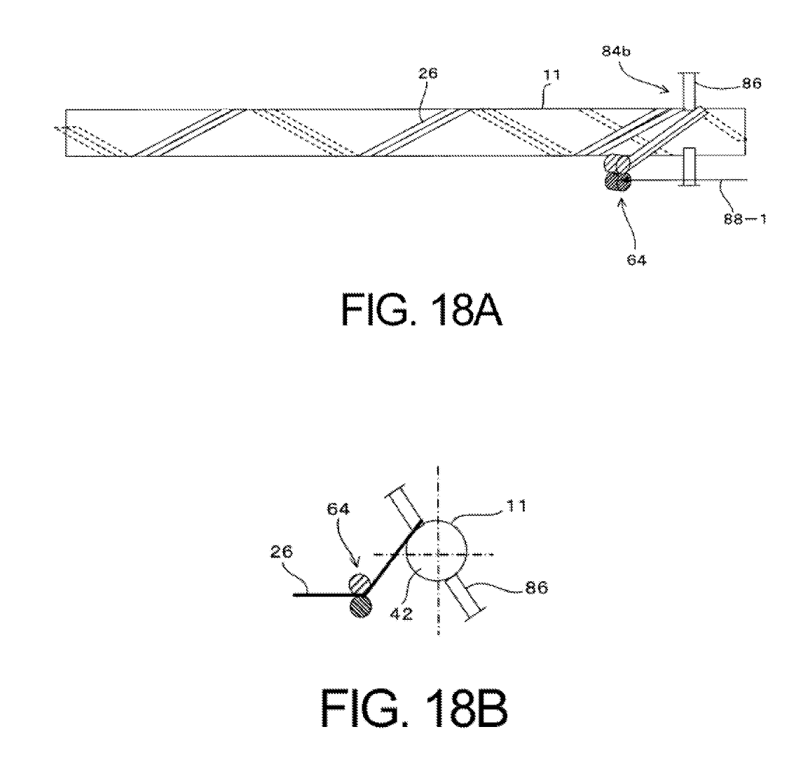

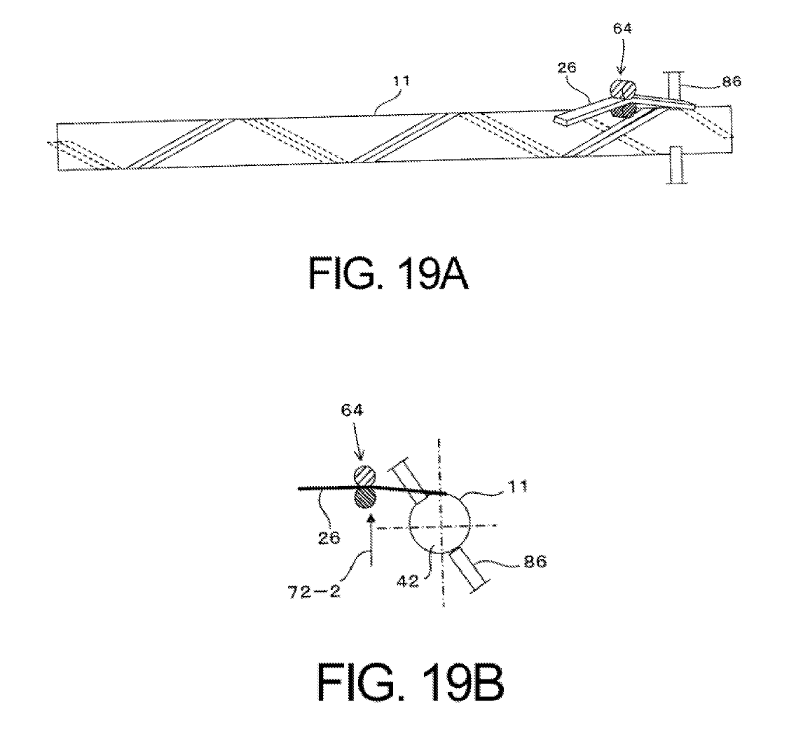

Next, as illustrated in FIG. 18A the guide head 64 is moved just an adequate distance in the first feeding direction 88-1 so as to pass beside the latching member 84b. Next, as illustrated in FIGS. 19A and 19B, when the guide head 64 is raised as indicated by the arrow 72-2 while slightly rotating the mandrel 42 in the first rotating direction 74-1, a state where the composite strip material 26 is supplied to a top side of the mandrel 42 is obtained.

By vertically inverting the guide head 64 by rotating in the direction indicated by the arrow Y the directions that the opposite side surfaces of the composite strip material 26 that is guided by the guide head 64 face are alternated between upward-facing and downward-facing. This is done so that the side surface 30 of the composite strip material 26 that is abutted against the peripheral surface of the inner tube 11 in the second winding pass forming step where the composite strip material 26 is supplied to the bottom side of the mandrel 42 is also abutted against the peripheral surface of the inner tube 11 in the third winding pass forming step where the composite strip material 26 is supplied to the top side of the mandrel 42.

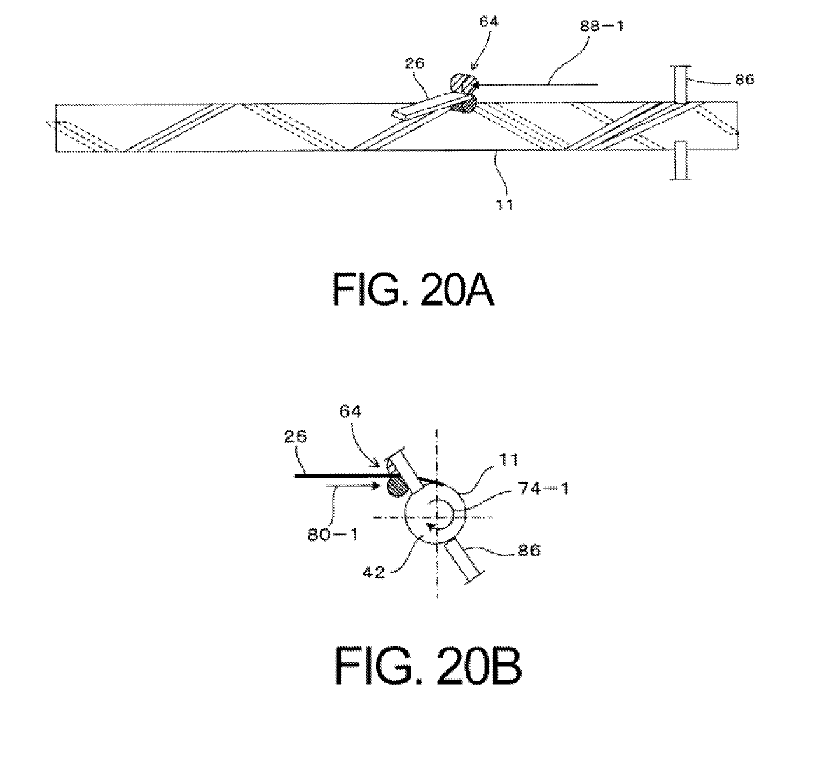

Next, as illustrated in FIG. 20B, the guide head 64 is moved in the direction 80-1 so as to approach the mandrel 42. From here, as illustrated in FIG. 20A, the third winding pass forming step of the plurality of winding pass forming steps performed to form the first unit layer 90 begins and the carriage 56 is fed in the first feeding direction 88-1.

In the reversing process performed at each of the left and right ends of the mandrel 42 described above, the guide head 64 is vertically inverted so that the same side surface 30 of the composite strip material 26 will constantly face the circumferential surface of the mandrel 42. As illustrated in FIGS. 2B and 2C, when using a composite strip material in which the steel cords 12 are exposed from the first side surface 30 of the unvulcanized rubber strip 38 as the composite strip material 26, it is preferable that the same side surface of the composite strip material 26 wound around the inner tube 11 faces towards the mandrel 42 because, by using such an arrangement, interference of the steel cords 12 of vertically proximate unit layers can easily be avoided. For example, with the rubber hose 10 illustrated in FIG. 1B, the first side surface 30 of the composite strip material 26 wound around the inner tube 11 is arranged to be facing the mandrel 42. Therefore in FIG. 1B, the steel cords 12 appear to be exposed to the peripheral surface of each of the unit layers 90, 92, 94, 96.

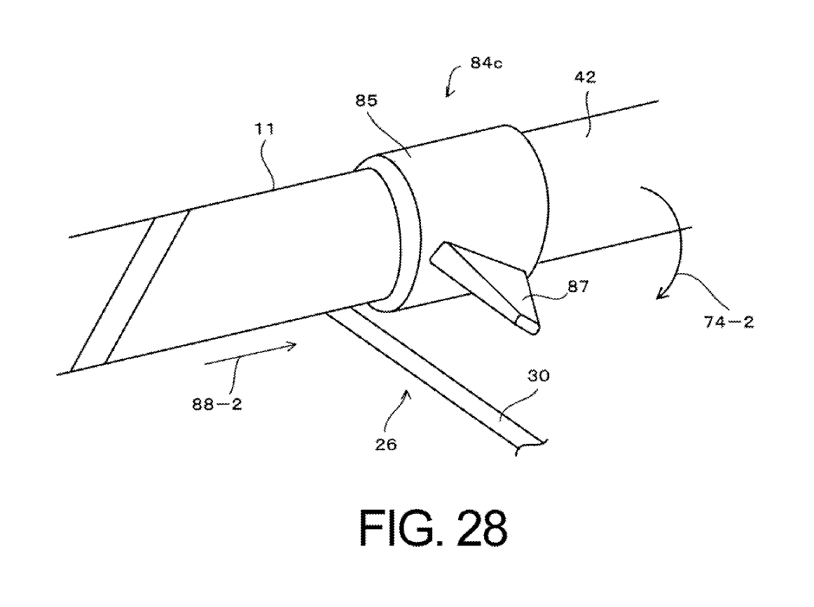

Additionally, in the reversing process at the left end of the mandrel 42, the guide head 64 is rotated counterclockwise and vertically inverted, and in the reversing process at the right end of the mandrel 42 the guide head 64 is rotated clockwise and vertically inverted. Rotation in mutually opposite directions in this way is performed in order to prevent an accumulation of twisting in the portion of the composite strip material 26 extending between the guide head 64 and the drum 60. Furthermore, because the rotating directions of the guide head 64 are mutually opposite directions perfect symmetry does not exist between the reversing process at the left end and the reversing process at the right end. Actually, as illustrated, when using the latching members 84a, 84b provided with the pair of pins 86, compared to the reversing process at the left end, the reversing process at the right end has a higher risk of failing to catch the composite strip material 26. FIGS. 28 to 33 illustrate a latching member 84c according to a modified embodiment that is used in place of the latching member 84b on the right end of the mandrel 42 described above in order to ensure that the reversing process at the right end of the mandrel 42 is performed more reliably.

As illustrated in FIG. 28, the latching member 84c attached to the right side of the mandrel 42 is configured by a sleeve 85 that interlocks with a periphery of the mandrel 42 and a trapezoidal plate 87 that is fixed to the sleeve 85 and protrudes outward from the mandrel 42 in a radial direction of the mandrel 42. The trapezoidal plate 87 has opposite side surfaces and opposite side edges, and the closer to an end thereof, or, in other words, the further outward from the mandrel 42 in the radial direction, the narrower a width thereof becomes. Additionally, the opposite side surfaces of the trapezoidal plate 87 incline and expand at an angle of about 45 degrees with respect to the axial center of the mandrel 42.

When the composite strip material 26 has been wound forward in the second feeding direction 88-2 from the left end of the mandrel 42 toward the right end, the composite strip material 26 will be supplied to the bottom side of the mandrel 42 (see FIG. 28) and the first side surface 30 of the composite strip material 26 will be abutted against the peripheral surface of the inner tube 11 on the mandrel 42. Additionally, at this time, the mandrel 42 rotates in the second rotating direction 74-2 in order to pick up the composite strip material 26 supplied to the bottom side of the mandrel 42 and the carriage 56 (see FIG. 3) is fed in the second feeding direction 88-2. Because the guide head 64 (see FIG. 3) moves along with the carriage 56, the composite strip material 26 is wound forward in the second winding forward direction 88-2.

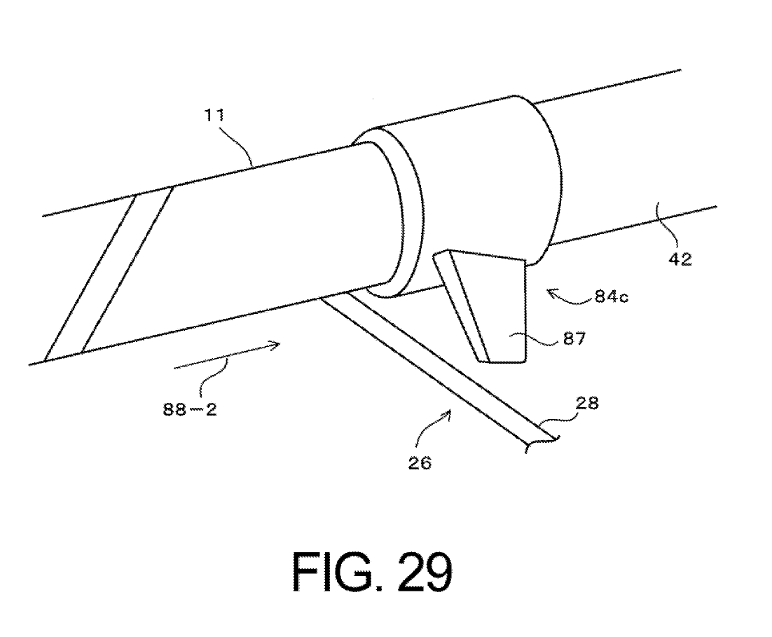

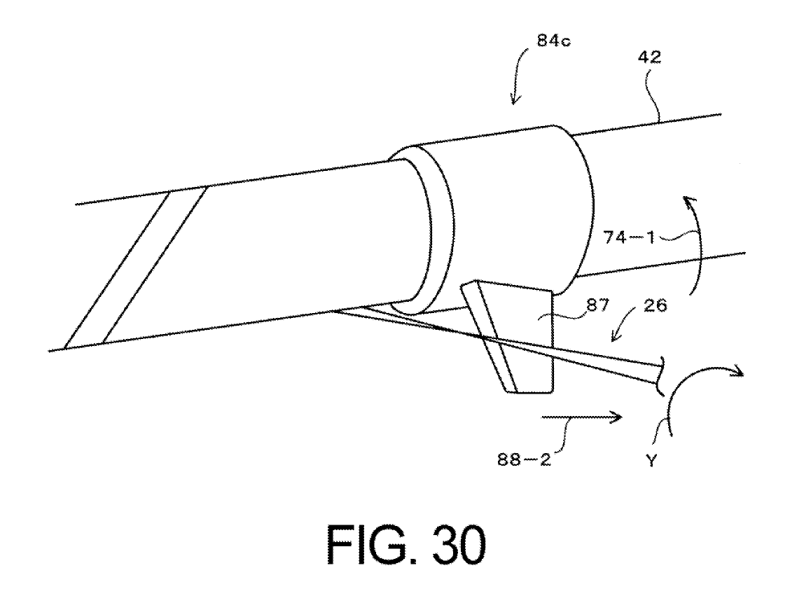

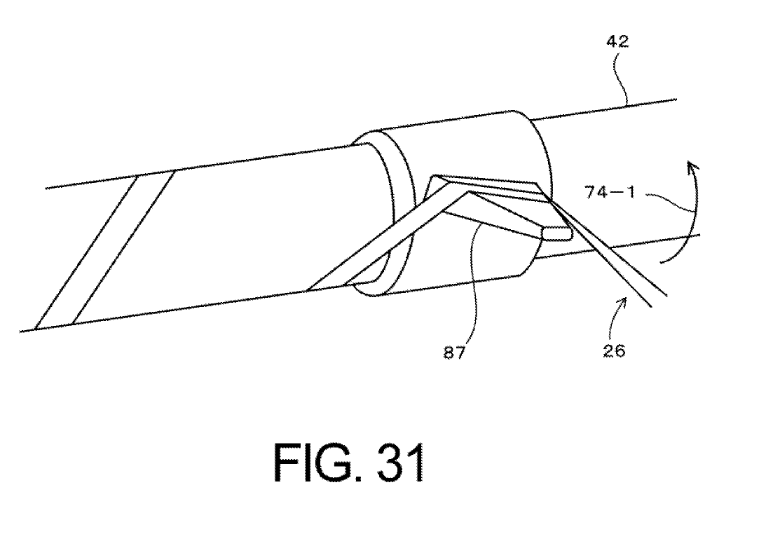

When the composite strip material 26 has been wound forward to immediately before the latching member 84c, winding is stopped by stopping the rotation of the mandrel 42 and stopping the feeding of the carriage 56. Then, the guide head 64 is moved in a direction away from the mandrel 42 as illustrated in FIG. 29. Thereafter, the guide head 64 is rotated as illustrated in FIG. 30. Specifically, as indicated by the arrow Y in FIG. 30, the guide head 64 is vertically inverted by rotating the guide head 64 180 degrees clockwise (when viewed in a direction towards the mandrel 42) around the axial center extending in the longitudinal direction of a portion of the composite strip material 26 extending between the mandrel 42 and the guide head 64. Thereby, the portion of the composite strip material 26 extending between the mandrel 42 and the guide head 64 is provided with a 180 degree twist. Next, the mandrel 42 is rotated in the first rotating direction 74-1 while moving the guide head 64 in the second feeding direction 88-2 so as to pass beside the latching member 84c. Thereby, as illustrated in FIG. 31, the side surface 30 of the composite strip material 26 (the side surface abutted against the circumferential surface of the inner tube 11) is hooked and latched to the opposite side edges of the trapezoidal plate 87, and thereby, the composite strip material 26 is latched onto the latching member 84c.

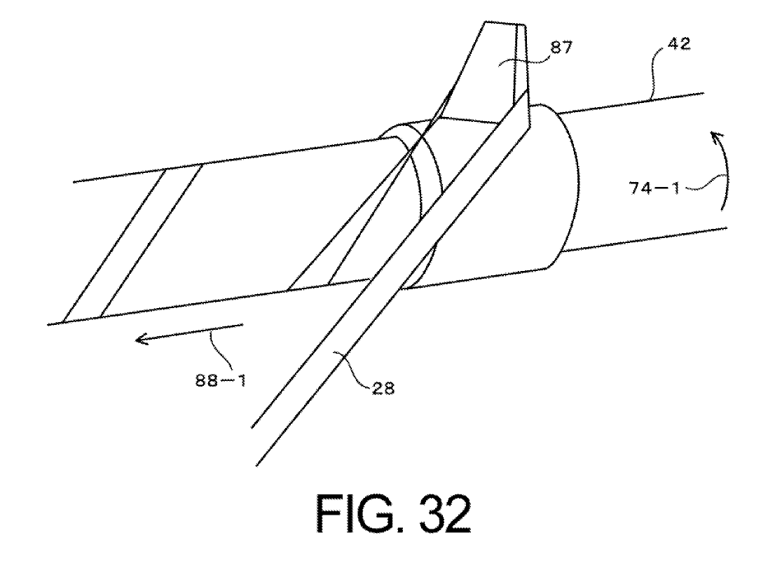

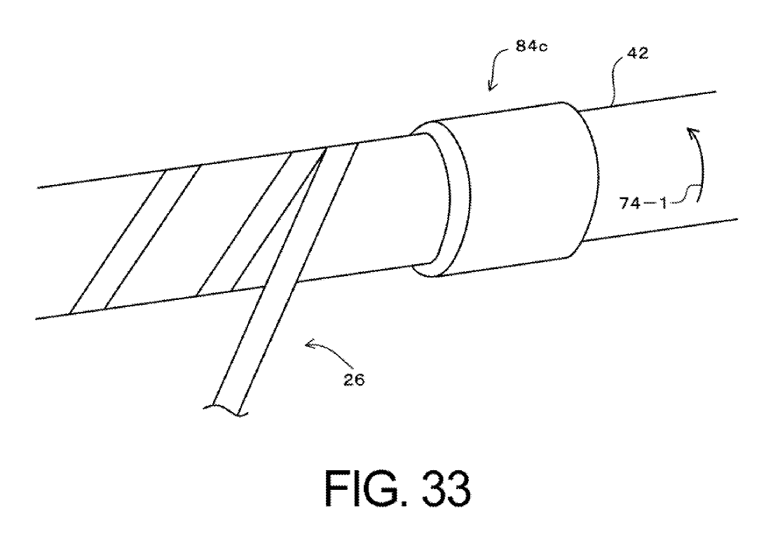

Next, as illustrated in FIG. 32, along with rotating the mandrel 42 in the first rotating direction 74-1, the guide head 64 is moved in the first feeding direction 88-1 so as to pass beside the latching member 84c. Thereafter, as illustrated in FIG. 33, the subsequent winding pass forming step is performed. When using the latching member 84c, the side surface 30 of the composite strip material 26 latched thereon fits well with the opposite side edges of the trapezoidal plate 87 that has a width that narrows with proximity to the end, and also the extending direction of the composite strip material 26 reversed at the opposite side edges is oriented in a proper direction. Therefore, reliability of the reversing process can be enhanced.

With the winding process of the composite strip material described above, the helix angle (and therefore the helix angle of the steel cords 12) of the composite strip material 26 that is helically wound is determined as a function of a diameter of the unit layer to be formed, a number N of strips of the composite strip material helically wound so as to be juxtaposed, and the width dimension W of the composite strip material 26. Thus, the width dimension W of the composite strip material 26 is appropriately set in advance based on a target helix angle of the steel cords 12 of the rubber hose to be manufactured. Additionally, when the first to the fourth unit layers 90 to 96 are formed using the same composite strip material 26, because the diameters of the unit layers differ, the helix angles of the steel cords 12 in the unit layers mutually differ. The helix angle of the first unit layer 90 is largest and the helix angle of the fourth unit layer 96 is smallest. Thus, if it is desirable that the helix angle of the steel cords 12 in all of the unit layers be identical, then it is acceptable that the unit layers be formed using composite strip materials that each have differing width dimensions. Specifically, it is acceptable that the width dimension W of each of the composite strips be set appropriately such that a width dimension of the composite strip material forming the first unit layer 90 be the smallest and a width dimension of the composite strip material forming the fourth unit layer 96 be the largest.

Furthermore, when winding the composite strip material 26 around the inner tube 11 or around the formed unit layer, it is beneficial to apply a powder of a sulfur-containing substance (i.e. sulfur powder) to the surface of the composite strip material 26. This is particularly beneficial when using a composite strip material 26 in which the circumferential surface of the steel cords 12 are exposed from one side of the unvulcanized rubber strip 38 and the circumferential surface of the steel cords 12 are brass-plated, as illustrated in FIGS. 2B and 2C, because by applying this type of powder, when vulcanizing later, adhesion strength between the surface of the brass-plated steel cords 12 that is exposed from the composite strip material 26 of one of the unit layers and the surface of the unvulcanized rubber strip 38 of the composite strip material 26 of the adjacent unit layer will be enhanced.

Furthermore, in the winding method of the composite strip material described above, the composite strip material 26 is preferably wound around the inner tube 11 or around the formed unit layer (specifically, on the base peripheral surface upon which the unit layer is newly formed) while applying tension to the composite strip material 26 using an appropriate method. Thereby, the composite strip material 26 can be wound therearound in stable state.

As described above, the unvulcanized laminated reinforcing layer 14 is formed by repeating the process of forming the unit layer and forming a plurality of the unit layers 90 to 96 that are laminated on each other. Next, the outer tube 24 covering a surface of the laminated reinforcing layer 14 is formed on a periphery of the unvulcanized laminated reinforcing layer 14. This process can be performed using the strip material helical winding device 28. For example a strip material, which is the material of the outer tube 24, formed from unvulcanized rubber that will become wear resistant rubber after vulcanizing is wound around the drum 60 of the strip material supplier 50 and stored in this drum 60, and thereafter the unvulcanized rubber strip material is helically wound on the surface of the unvulcanized laminated reinforcing layer 14. In this case, winding is performed so that an overlapping portion exists between one side edge of the unvulcanized rubber strip material in one turn and another side edge in a subsequent turn.

Then, the mandrel 42 is removed from the strip material helical winding device 28, placed in a vulcanization device, and then the unvulcanized rubber hose 10 formed on the mandrel 42 is vulcanized in the vulcanization device. Thereafter, the vulcanized rubber hose 10 is removed from the mandrel 42. With the rubber hose obtained in this manner, the composite strip material 26 is hooked and latched onto the latching member 46, 48 of the mandrel 42 in the reversing process. Therefore, a degree of disorder of the arrangement of the steel cords 12 at both ends may occur. Thus, a final product is obtained by cutting off the portions where the arrangement of the steel cords 12 is in disorder at both ends of the rubber hose.

1. A method of manufacturing a rubber hose reinforced by a plurality of helically arranged steel cords comprising the steps of:
fabricating a composite strip material comprising opposite side surfaces and opposite side edges, wherein the composite strip material comprises an unvulcanized rubber strip and a plurality of reinforcing steel cords provided in the unvulcanized rubber strip so as to be arranged in a mutually juxtaposed manner and extend in a longitudinal direction of the unvulcanized rubber strip;
fabricating a flexible inner tube that forms an innermost layer of the rubber hose; and
forming a laminated reinforcing layer comprising a plurality of the helically arranged steel cords around the inner tube by: winding the composite strip material around the inner tube; forming a wound body having a laminated structure formed by laminating a plurality of unit layers on each other, and, at that point, forming one unit layer on the inner tube and then sequentially forming another unit layer on the formed unit layer; and thereafter subjecting the unvulcanized rubber strip of the wound composite strip material to vulcanization;
wherein
when forming each of the unit layers, one side surface of the composite strip material is abutted against a base peripheral surface upon which the unit layer is formed; and a side edge of the composite strip material forming one turn of the helix and a side edge of the composite strip material forming the turn adjacent thereto are brought into close contact, and the composite strip material is helically wound on the base peripheral surface, so that the base peripheral surface is covered by the composite strip material; and, furthermore,
when forming each of the unit layers, a single continuous strip of the composite strip material is used; and each of the unit layers is formed by alternately repeating a winding pass forming step in a first winding forward direction for helically winding the composite strip material in a first direction of the longitudinal direction of the base peripheral surface in a given helix direction, at a given helix angle, and at a given pitch of a whole number multiple of a width dimension of the composite strip material; and a winding pass forming step in a second winding forward direction for winding the composite strip material in a second direction that is a direction opposite the first direction of the longitudinal direction of the base peripheral surface in the given helix direction, at the given helix angle, and at the given pitch.

2. The method of manufacturing a rubber hose reinforced by a plurality of helically arranged steel cords according to claim 1, wherein when alternating from the winding pass forming step in the first winding forward direction to the winding pass forming step in the second winding forward direction, the winding forward direction is reversed and also a relative winding direction of the composite strip material with respect to the base peripheral surface is reversed.

3. The method of manufacturing a rubber hose reinforced by a plurality of helically arranged steel cords according to claim 1, formed by alternately laminating a unit layer formed by winding the composite strip material in the first helix direction and a unit layer formed by winding the composite strip material in a second helix direction that is the direction opposite the first helix direction.

4. The method of manufacturing a rubber hose reinforced by a plurality of helically arranged steel cords according to claim 1, wherein the composite strip material is wound on the base peripheral surface while applying tension to the composite strip material.

5. The method of manufacturing a rubber hose reinforced by a plurality of helically arranged steel cords according to claim 1, further comprising a step of forming an outer tube around the laminated reinforcing layer that covers a surface of laminated reinforcing layer.

6. The method of manufacturing a rubber hose reinforced by a plurality of helically arranged steel cords according to claim 1, wherein the side surface of the single continuous strip of the composite strip material that is abutted against the base peripheral surface in the winding pass forming step in the first winding forward direction and the side surface of the single continuous strip of the composite strip material that is abutted against the base peripheral surface in the winding pass forming step in the second winding forward direction are side surfaces on the same side.

7. The method of manufacturing a rubber hose reinforced by a plurality of helically arranged steel cords according to claim 1, wherein an entirety of the steel cords of the composite strip material are completely embedded in the unvulcanized rubber strip.

8. The method of manufacturing a rubber hose reinforced by a plurality of helically arranged steel cords according to claim 1, wherein a portion of a circumferential surface of the steel cords of the composite strip material is embedded in the unvulcanized rubber strip and a remaining portion of the circumferential surface is exposed from a first side surface of the unvulcanized rubber strip.

9. A rubber hose reinforced by steel cords manufactured according to a manufacturing method according to claim 1.

10. The method of manufacturing a rubber hose reinforced by a plurality of helically arranged steel cords according to claim 1, wherein the reinforcing steel cords are brass plated.

11. The method of manufacturing a rubber hose reinforced by a plurality of helically arranged steel cords according to claim 1, further comprising facing a same side surface of the composite strip material wound around the inner tube towards the mandrel when using a composite strip material in which the reinforcing steel cords are exposed from the first side surface of the unvulcanized rubber strip to avoid interference of the reinforcing steel cords of vertically proximate unit layers.

12. The method of manufacturing a rubber hose reinforced by a plurality of helically arranged steel cords according to claim 1, further comprising applying a powder of a sulfur-containing substance to a surface of the composite strip material.

13. The method of manufacturing a rubber hose reinforced by a plurality of helically arranged steel cords according to claim 12, wherein the reinforcing steel cords are exposed from one side of the unvulcanized rubber strip and a circumferential surface of the steel cords is brass-plated.

14. The method of manufacturing a rubber hose reinforced by a plurality of helically arranged steel cords according to claim 1, further comprising applying a release agent to an inner surface of the inner tube and/or an outer surface of the mandrel.

15. The method of manufacturing a rubber hose reinforced by a plurality of helically arranged steel cords according to claim 1, wherein a pitch P of the helix is larger than a width dimension W of the composite strip material.

16. The method of manufacturing a rubber hose reinforced by a plurality of helically arranged steel cords according to claim 1, wherein a pitch P of the helix is N times a width dimension W of the composite strip material, where N is an integer greater than or equal to 2.

17. The method of manufacturing a rubber hose reinforced by a plurality of helically arranged steel cords according to claim 1, wherein the unit layers are formed using a same composite strip material and diameters of the unit layers differ; and wherein the helix angles of the reinforcing steel cords in the unit layers mutually differ.

18. The method of manufacturing a rubber hose reinforced by a plurality of helically arranged steel cords according to claim 1, wherein the helix angle of a first unit layer is larger than the helix angle of a fourth unit layer.

19. The method of manufacturing a rubber hose reinforced by a plurality of helically arranged steel cords according to claim 1, wherein the helix angle of the steel cords in the unit layers is identical and the unit layers are formed using composite strip materials that each have differing width dimensions.

20. The method of manufacturing a rubber hose reinforced by a plurality of helically arranged steel cords according to claim 1, wherein a width dimension W of each of the composite strips is such that a width dimension of the composite strip material forming a first unit layer is the smallest and a width dimension of the composite strip material forming a fourth unit layer is the largest.
